(19) United States
(12) Patent Application Publication
(10) Pub. No.: US 2021/0307888 A1
(43) Pub. Date: Oct. 7, 2021

(54) CLEANSING ATTACHMENT FOR ORAL CLEANSING DEVICE

(71) Applicant: WATER PIK, INC., Fort Collins, CO (US)

(72) Inventor: Robert D. WAGNER, Fort Collins, CO (US)

(21) Appl. No.: 17/270,551

(22) PCT Filed: Sep. 6, 2019
(86) PCT No.: PCT/US2019/050054

§ 371 Date: Feb. 23, 2021

Related U.S. Application Data
(60) Provisional application No. 62/728,258, filed on Sep. 7, 2018.

(51) Int. Cl. A61C 17/36; A61C 17/22; A61C 17/02

(52) U.S. Cl. CPC A61C 17/36; A61C 17/0202; A61C 17/222

(57) ABSTRACT

An oral cleansing device (e.g., an irrigating, electric toothbrush) is disclosed. The oral cleansing device includes a handle, a cleansing attachment (e.g., a brush head attachment), and an irrigating attachment (e.g., an oral irrigator tip). The handle includes one or more control buttons to activate motion of an output shaft and/or an irrigating feature of the oral cleansing device. The cleansing attachment includes a plurality of bristles and is attachable to the handle such that movement of the output shaft is transferred to the cleansing attachment. The irrigating attachment defines an internal fluid passageway for receiving fluid from the handle and is attachable to the handle such that movement of the output shaft is not transferred to the irrigating attachment.

### CROSS-REFERENCED TO RELATED APPLICATIONS

This application claims priority to U.S. Provisional Application No. 62/728,258, filed Sep. 7, 2018, entitled “Cleansing Attachment for Oral Cleansing Device,” which is incorporated herein by reference in its entirety.

### TECHNICAL FIELD

The present disclosure relates to oral health products. More specifically, the present disclosure relates to toothbrush and oral irrigating brushing devices and corresponding cleansing attachments and accessories.

### BACKGROUND

The state of the art in sonic toothbrush technology centers around drive systems that create a desired oscillating toothbrush output motion by using electro-magnetic drivers and centering return springs to directly create oscillating motion. No continuous input rotation or drivers are involved in these electro-magnetic systems and such electro-magnetic systems have a relatively high production cost.

There are also currently many toothbrushes that provide oscillating output brush motion from continuously rotating input drivers. Such mechanically-driven toothbrushes typically have a reduced manufacturing cost as compared to toothbrushes employing electro-magnetic drivers. However, such rotating systems all perform the oscillating function at lower speeds.

Present oral irrigator devices are standalone units that provide a pulsing water jet stream using a dedicated, unique handle and an irrigating tip. There are some devices known as “combo” units that provide toothbrush function along with an irrigating function from a single unit. These devices essentially take an oral irrigation base unit with a handle and tip assembly, enlarge the base unit, and add a separate toothbrush handle that sits on the enlarged base. Two handles are required to provide each of irrigation and toothbrush functions.

The information included in this Background section of the specification, including any references cited herein and any description or discussion thereof, is included for technical reference purposes only and is not to be regarded subject matter by which the scope of the invention as defined in the claims is to be bound.

### SUMMARY

A cleansing attachment, such as an oral irrigator tip, for use with an oral cleansing device is disclosed. In one example, the cleansing attachment includes a shaft defining an internal fluid passageway for receiving fluid from the device, a brush head attached to the shaft, a plurality of bristles attached to the brush head, and a nozzle formed integrally with the brush head and in fluid communication with the fluid passageway for expelling the fluid from the brush head.

In another example, the cleansing attachment includes a shaft defining an internal fluid passageway for receiving fluid from the device, a brush head attached to the shaft and defining a cavity in fluid communication with the fluid passageway, and first and second nozzles associated with the brush head and in fluid communication with the cavity for expelling fluid from the brush head.

In another example, the cleansing attachment includes a shaft defining an internal fluid passageway for receiving fluid from the device, a brush head attached to the shaft and defining a cavity in fluid communication with the fluid passageway, and a nozzle associated with the brush head and including multiple outlet ports in fluid communication with the cavity for expelling the fluid from the brush head.

In another example, the cleansing attachment comprises an oral irrigator tip, and the oral irrigator tip comprises an elongate shaft defining an internal fluid passageway for receiving fluid from the electrically-powered cleansing device, and a securing assembly operatively coupled to the shaft for selectively attaching the shaft to the electrically-powered cleansing device in a manner preventing transfer of motion from an output shaft of the electrically-powered cleansing device to the irrigator tip.

In another example, an oral cleansing device includes a handle, a cleansing attachment, and an irrigating attachment. The handle includes one or more control buttons to activate motion of an output shaft and/or an irrigating feature. The cleansing attachment includes a plurality of bristles and is attachable to the handle such that movement of the output shaft is transferred to the cleansing attachment. The irrigating attachment defines an internal fluid passageway for receiving fluid from the handle. The irrigating attachment is attachable to the handle such that movement of the output shaft is not transferred to the irrigating attachment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1A is an isometric view of an irrigating toothbrush.

FIG. 1B is an isometric partially exploded view of the irrigating toothbrush of FIG. 1A.

FIG. 1C is an enlarged cross-section view of the irrigating toothbrush taken along line 1C-1C in FIG. 1A.

FIG. 1D is an enlarged cross-section view of the irrigating toothbrush similar to FIG. 1C, but showing another example of a cleansing implement and securing assembly.

FIG. 2A is a front isometric view of a cleansing implement for use with the device of FIG. 1A.

FIG. 2B is a rear isometric view of the cleansing implement of FIG. 2A.

FIG. 2C is a front elevation view of the cleansing implement of FIG. 2A.

FIG. 2D is a bottom plan view of the cleansing implement of FIG. 2A.

FIG. 2E is a cross-section view of the cleansing implement of FIG. 2A taken along line A-A in FIG. 2D.

FIG. 2F is an exploded view of the cleansing implement of FIG. 2A.

FIG. 2G is another exploded view of the cleansing implement of FIG. 2A.

FIG. 2H is a front elevation view of another example of a cleansing implement similar to FIG. 2A.

FIG. 2I is a cross-section view taken along line B-B in FIG. 2H.

FIG. 3A is a front isometric view of an example of a cleansing implement.

FIG. 3B is a rear isometric view of the cleansing implement of FIG. 3A.

FIG. 3C is a front elevation view of the cleansing implement of FIG. 3A.

FIG. 3D is a bottom plan view of the cleansing implement of FIG. 3A.

FIG. 3E is a cross-section view of the cleansing implement of FIG. 3A taken along line E-E in FIG. 3D.

FIG. 3F is a front exploded view of the cleansing implement of FIG. 3A.

FIG. 3G is a rear exploded view of the cleansing implement of FIG. 3A.

FIG. 3H is an enlarged cross-section view of the cleansing implement of FIG. 3A taken along line E-E in FIG. 3D.

FIG. 3I is an enlarged cross-section view of another example of the cleansing implement of FIG. 3A.

FIG. 3J is an enlarged cross-section view of yet another example of the cleansing implement of FIG. 3A.

FIG. 4A is a front isometric view of another example of a cleansing implement.

FIG. 4B is a rear isometric view of the cleansing implement of FIG. 4A.

FIG. 4C is front elevation view of the cleansing implement of FIG. 4A.

FIG. 4D is a bottom plan view of the cleansing implement of FIG. 4A.

FIG. 4E is a cross-section view of the cleansing implement of FIG. 4A taken along line AG-AG in FIG. 4D.

FIG. 4F is a front exploded view of the cleansing implement of FIG. 4A.

FIG. 4G is a rear exploded view of the cleansing implement of FIG. 4A.

FIG. 4H is a front isometric view of another example of a cleansing implement similar to FIG. 4A.

FIG. 4I is a cross-section view of the cleansing implement of FIG. 4H taken along line AH-AH in FIG. 4H.

FIG. 4J is a front exploded view of the cleansing implement of FIG. 4H.

FIG. 4K is a rear exploded view of the cleansing implement of FIG. 4H.

FIG. 5A is a front isometric view of another example of a cleansing implement.

FIG. 5B is a front elevation view of the cleansing implement of FIG. 5A.

FIG. 5C is a bottom plan view of the cleansing implement of FIG. 5A.

FIG. 5D is a rear isometric view of the cleansing implement of FIG. 5A.

FIG. 5E is a cross-section view of the cleansing implement of FIG. 5A.

FIG. 5F is a front exploded view of the cleansing implement of FIG. 5A.

FIG. 5G is a rear exploded view of the cleansing implement of FIG. 5A.

FIG. 6A is a front isometric view of another example of a cleansing implement.

FIG. 6B is a bottom plan view of the cleansing implement of FIG. 6A.

FIG. 6C is a cross-section view of the cleansing implement of FIG. 6A taken along line AJ-AJ in FIG. 6B.

FIG. 6D is a front elevation view of the cleansing implement of FIG. 6A.

FIG. 6E is a cross-section view of the cleansing implement of FIG. 6A taken along line AK-AK in FIG. 6D.

FIG. 6F is a front elevation view of a variation of the cleansing implement of FIG. 6A.

FIG. 6G is a cross-section view of the cleansing implement of FIG. 6F taken along line AA-AA in FIG. 6F.

FIG. 7A is a front isometric view of another example of a cleansing implement.

FIG. 7B is a bottom plan view of the cleansing implement of FIG. 7A.

FIG. 7C is a cross-section view of the cleansing implement of FIG. 7A taken along line AD-AD in FIG. 7B.

FIG. 7D is front elevation view of the cleansing implement of FIG. 7A.

FIG. 7E is a cross-section view of the cleansing implement of FIG. 7A taken along line AF-AF in FIG. 7D.

FIG. 8A is a front isometric view of another example of a cleansing implement.

FIG. 8B is a rear isometric view of the cleansing implement of FIG. 8A.

FIG. 8C is a front elevation view of the cleansing implement of FIG. 8A.

FIG. 8D is a bottom plan view of the cleansing implement of FIG. 8A.

FIG. 8E is a cross-section view of the cleansing implement of FIG. 8A taken along line L-L in FIG. 8D.

FIG. 8F is a front exploded view of the cleansing implement of FIG. 8A.

FIG. 8G is a rear exploded view of the cleansing implement of FIG. 8A.

FIG. 8H is a front elevation view of another variation of the cleansing implement of FIG. 8A.

FIG. 9A is front isometric view of another example of a cleansing implement.

FIG. 9B is a rear isometric view of the cleansing implement of FIG. 9A.

FIG. 9C is rear elevation view of the cleansing implement of FIG. 9A.

FIG. 9D is a bottom plan view of the cleansing implement of FIG. 9A.

FIG. 9E is a cross-section view of the cleansing implement of FIG. 9A taken along line R-R in FIG. 9D.

FIG. 9F is a rear exploded view of the cleansing implement of FIG. 9A.

FIG. 9G is a rear isometric view of another variation of the cleansing implement of FIG. 9A.

FIG. 9H is a rear elevation view of the cleansing implement of FIG. 9G.

FIG. 9I is a cross-section view of the cleansing implement of FIG. 9A taken along line U-U in FIG. 9H.

FIG. 10A is a front isometric view of another example of a cleansing implement.

FIG. 10B is a rear isometric view of the cleansing implement of FIG. 10A.

FIG. 10C is a bottom plan view of the cleansing implement of FIG. 10A.

FIG. 10D is a cross-section view of the cleansing implement of FIG. 10A taken along line A-A in FIG. 10C.

FIG. 10E is a rear exploded view of the cleansing implement of FIG. 10A.

FIG. 10F is a front exploded view of the cleansing implement of FIG. 10A.

FIG. 10G is a cross-section view of the cleansing implement of FIG. 10A similar to FIG. 10D but shown attached to the output shaft of the device of FIG. 1A.

FIG. 11A is a front isometric view of another example of a cleansing implement.

FIG. 11B is a rear isometric view of the cleansing implement of FIG. 11A.

FIG. 11C is a bottom plan view of the cleansing implement of FIG. 11A.

FIG. 11D is a cross-section view of the cleansing implement of FIG. 11A taken along line A-A in FIG. 11C.

FIG. 11E is a rear exploded view of the cleansing implement of FIG. 11A.

FIG. 11F is a front exploded view of the cleansing implement of FIG. 11A.

FIG. 12A is a front isometric view of another example of a cleansing implement.

FIG. 12B is a rear isometric view of the cleansing implement of FIG. 12A.

FIG. 12C is a bottom plan view of the cleansing implement of FIG. 12A.

FIG. 12D is a cross-section view of the cleansing implement of FIG. 12A taken along line A-A in FIG. 12C.

FIG. 12E is a rear exploded view of the cleansing implement of FIG. 12A.

FIG. 12F is a front exploded view of the cleansing implement of FIG. 12A.

FIG. 13A is a front isometric view of another example of a cleansing implement.

FIG. 13B is a rear isometric view of the cleansing implement of FIG. 13A.

FIG. 13C is a cross-section view of the cleansing implement of FIG. 13A taken along line A-A in FIG. 13B.

FIG. 14A is a front isometric view of another example of cleansing implement.

FIG. 14B is a rear isometric view of the cleansing implement of FIG. 14A.

FIG. 14C is a front elevation view of the cleansing implement of FIG. 14A.

FIG. 14D is a cross-section view of the cleansing implement of FIG. 14A taken along line A-A in FIG. 14C.

FIG. 14E is a cross-section view of the cleansing implement of FIG. 14A taken along line B-B in FIG. 14D.

FIG. 14F is a cross-section view of the cleansing implement of FIG. 14A taken along line C-C in FIG. 14E.

FIG. 14G is a front exploded view of the cleansing implement of FIG. 14A.

FIG. 14H is a rear exploded view of the cleansing implement of FIG. 14A.

FIG. 14I is a rear exploded view of another variation of the cleansing implement of FIG. 14A.

FIG. 15A is a rear exploded view of another variation of the cleansing implement of FIG. 14A.

FIG. 15B is a front elevation view of the cleansing implement of FIG. 15A.

FIG. 15C is a cross-section view of the cleansing implement of FIG. 15A taken along line A-A in FIG. 15B.

FIG. 16A is a cross-section view of a cleansing implement before use.

FIG. 16B is a cross-section view of the cleansing implement during use with proper brushing force applied by a user.

FIG. 16C is a cross-section view of a cleansing implement during use that is worn and/or experiencing an improper brushing force.

FIG. 16D is a cross-section view of a worn out or damaged cleansing implement.

### DETAILED DESCRIPTION

The present disclosure generally relates to various working implements or working pieces for oral cleansing devices, such as toothbrush heads and irrigating heads. Many embodiments may be used with combination oral cleansing devices, e.g., irrigating, electrically driven toothbrushes, and as such may include an irrigating outlet to deliver fluid to a user's oral cavity, as well as bristles to frictionally remove debris, plaque, and the like, from a user's teeth. Other embodiments may be attachable to a combination irrigating/brushing device, but configured to provide a single output, e.g., irrigation only or brushing only. In these instances, the working attachment may be configured to block water flow or prevent motion of the attachment, respectively.

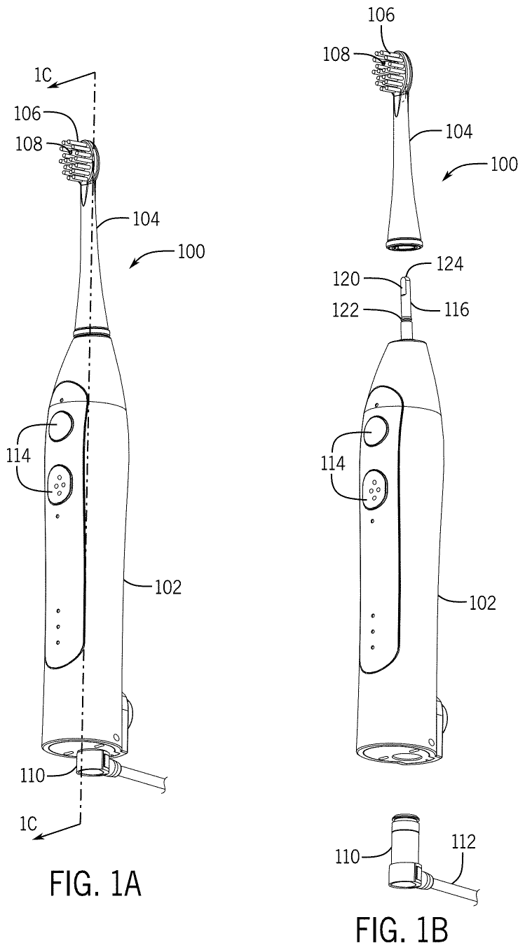

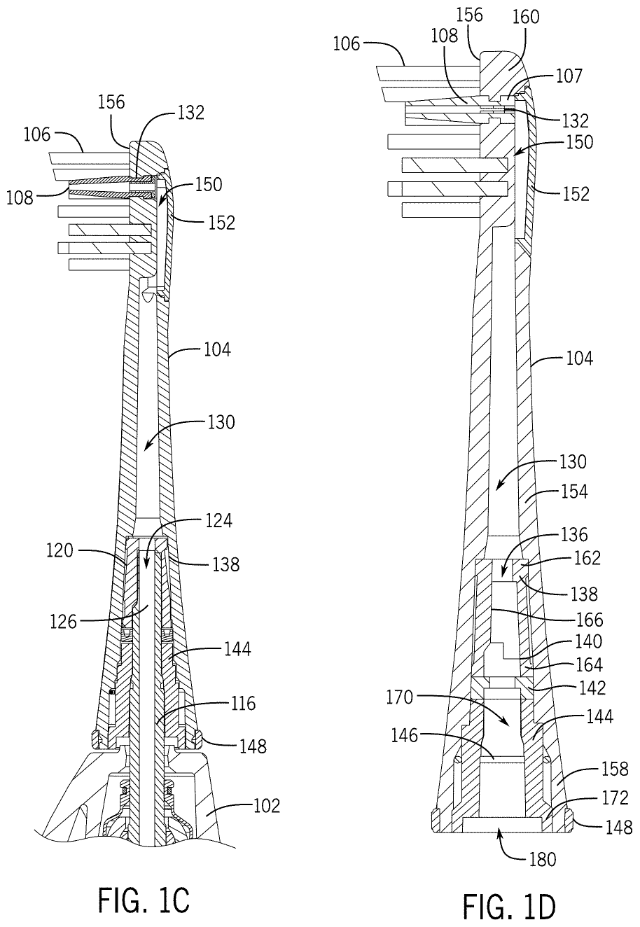

The cleaning tools disclosed herein may be connectable to substantially any type of handheld oral cleaning device. For example, the tools may be used with the devices disclosed in U.S. patent application Ser. No. 14/216,779 entitled “Mechanically-Driven, Sonic Toothbrush and Water Flosser” filed on Mar. 17, 2014 and U.S. patent application Ser. No. 15/206,013 entitled “Oral Cleansing Device with Energy Conservation” filed on Jul. 8, 2016, both of which are incorporated for all purposes herein. An exemplary cleansing device 100 is shown in FIGS. 1A and 1B and includes a handle 102 and a brush head or tip attachment 104 connected to the handle 102 and moveable in an oscillating manner relative to the handle 102 by an output shaft 116. The handle 102 includes a drive assembly or power train to activate a motion of the output shaft 116, causing the output shaft 116 to move a desired manner, typically in an oscillating motion.

The output shaft 116 may include a keyed top end having on or more keying surfaces 120 for securing the brush head 104 to the output shaft 116 and ensuring that motion is transferred from the output shaft 116 to the brush head 104. Additionally, the output shaft 116 may include a shaft outlet 124 at a top end thereof that is fluidly connected to the brush head 104 as discussed below. One or more securing grooves 122 or other securing elements may also be defined on the output shaft 116 to connect the brush head 104 to the handle 102.

The handle 102 may include one or more control buttons 114 for activating the motion of the output shaft 116 and/or to activate an irrigating feature and deliver water to the brush head 104. To this end, the device 100 may include a fluid connector 110 that connects to a reservoir via a hose 112 or other connection. A fluid pathway is defined through the handle 102 such that fluid from the hose 112 can travel through the handle 102 and to the output shaft 116, which may be hollow or otherwise include a fluid path, and then out of the end of the output shaft 116 into the brush head 104.

In particular, the brush head 104 may include a nozzle 108 or other outlet through which fluid in the brush head 104 can be expelled, such as into a user's oral cavity. The positioning, shape, configuration, material, and other characteristics of the nozzle 108 may be varied based on a desired output from the device 100. FIGS. 1C and 1D illustrate enlarged cross-section views of an exemplary brush head 104 attached to the handle 102 (FIG. 1C) and disconnected from the handle 102 (FIG. 1D). With reference to these figures, the brush head 104 may include a main body or tip shaft 154 that defines a fluid passageway 130 in fluid communication with a head fluid cavity 150 defined by the brush head face 156 and a tip cap 152. The head fluid cavity 150 is fluidly connected to the nozzle 108 and defines a compartment for receiving fluid to be delivered to the nozzle 108.

The brush head face 156 may form a bristle base for one or more bristles 106 or bristle tufts secured thereto and arranged about the face 156. In addition, the brush head face 156 defines a nozzle aperture that receives the nozzle 108.

The brush head 104 also houses a plurality of connection and sealing components or assemblies to selectively secure the head 104 to the handle 102. In some instances, the tip shaft 154 expands outwards towards a bottom end to accommodate the connection features, as well as provide an aesthetically pleasing appearance. The tip shaft 154 terminates in a tip opening 180.

A trim ring 148 may be attached to the base 158 of the tip shaft 154 to allow multiple users of the device 100 to easily identify their personal brush head 104 for attachment to the handle 102. For example, the trim ring 148 may be various colors to identify different user's brushes. The inner wall of the colored trim ring 148 may define a number of retention detents that may snap into the retention groove on the shaft to retain the colored trim ring 148 around the base of the brush head 104.

An elastomeric jet nozzle 108 is positioned within the nozzle aperture 107 and extends normal to the brush head face 156 approximately the same distance as the bristle tufts 106. The nozzle 108 defines a fluid lumen, is generally conical, and tapers in diameter from its base to its tip. The head fluid cavity 150 is formed in the back of the face portion 160 of the brush head 104 to provide access to the nozzle aperture 107 and a fluid flow connection between the nozzle aperture and the tip fluid passage 130. The cavity 150 may be enclosed by the tip cap 152 or brush head plug 152 that snaps into the sidewalls defining the cavity 150 and is ultrasonically welded or otherwise adhered to provide a fluid-tight seal in the face portion 160.

A retainer 138 may be inserted into and permanently affixed within the tip fluid passage 130 from the base end 158 of the tip shaft 154. The retainer 138 may be generally formed as a frustum with open sidewalls. A top ring 162 is joined to a larger diameter bottom ring 164 by an alignment rib 166 on one side and a support rib laterally opposed thereto. The top ring 162 defines an outlet aperture 136.

A sealing element 142, such as a U-cup, may be inserted into the tip fluid passage 130 of the tip shaft 154 below the retainer 138 and may be held in place against the retainer 138 by an end cap 144. In this exemplary implementation, the end cap 144 is formed as a series of stacked cylinders with decreasing diameters as they extend toward the face portion 160 or top end of the brush head 104. The end cap 144 defines a lumen 170 through which the output shaft 116 passes when the brush head 104 or brush assembly is placed on the handle 102. When the end cap 144 is inserted into the lumen 130 of the tip shaft 154, the base end 172 deflects and deforms to allow installation of the retainer posts of the end cap 314.

Clip slots may also be formed in the sidewall of the end cap 144 and may extend transversely through the end cap144 to retain spring retainer clip 146 therein to secure the output shaft 116 to the brush head 104. The spring retainer clip 146 may be formed from a piece of stiff wire to have a pair of clip arms that oppose each other and are joined at a clip arch. The free ends of the clip arms each form a reverse curve that opens away from the other. When the retainer clip 146 is installed in the clip slots, a portion of the spring clip 146 extends outside the end cap 144, while a portion is retained within the end cap 146. In this manner, the clip 146 clamps onto the corresponding features on the output shaft 116.

With reference to FIG. 1C, to secure the brush head 104 to the output shaft 116, the user places the brush head 104 onto the output shaft 116 and rotates the brush head 104 until an alignment flat 120 (see FIG. 1B) of the output shaft 116 mates with a keyed surface 166 of the retainer 138. Then, the user presses the brush head 104 onto the output shaft 116 until the lateral arms of the spring clip 146 seat within the clip recess 122 of the output shaft 116 (see FIG. 1B). The diameter of the output shaft 116 increases along a beveled edge immediately adjacent the clip recess 122. The clip arms of the spring retainer clip 146 expand laterally outward along this edge and then, when past the beveled edge, the clip arms contract laterally inward to lodge within the clip recess 122. Typically, an audible “click” can be heard by the user when the clip arms lodge within the clip recess 122 so that the user knows that the brush head 104 is securely attached to the handle 102. The gauge, material strength, and elasticity of the wire forming the spring retainer clip 146 are specifically chosen to ensure retention of the brush head 104 on the output shaft 116 under the operating pressures of the water jet function and further to reliably expand during engagement and disengagement of the brush head 104 over an appropriate number of cycles equivalent to or greater than an estimated life of the bristles 106. The keyed connection of the brush head 104 to the output shaft 116 allows the brush head 104 to move with the output shaft 116.

To disconnect a brush head 104 from the output shaft 116, the user pulls the brush head 104 away from the handle 102 with a sufficient force to overcome the force exerted by the clip arms of the spring clip 146, which causes the arms to deform and slide out of the clip recess 122, allowing the brush head 104 to be removed.

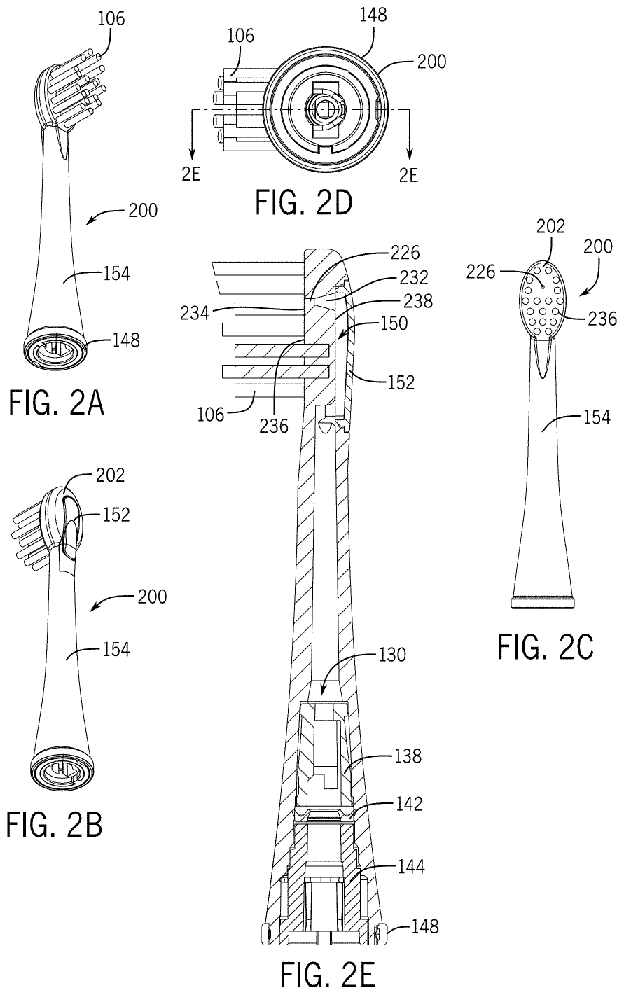

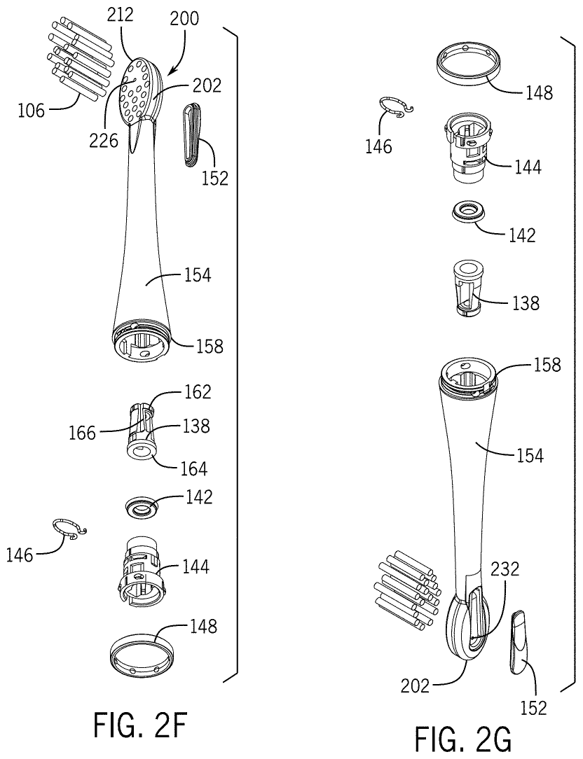

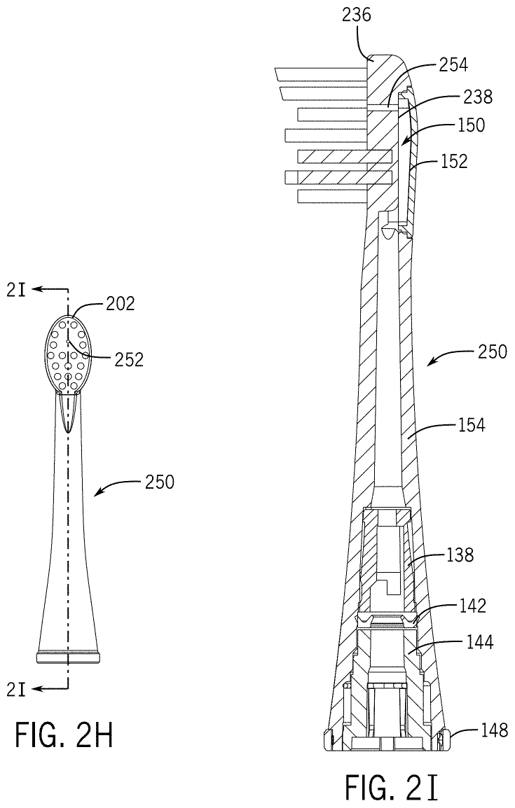

FIGS. 2A-2G illustrate a first example of a cleansing attachment that may be secured to the handle. The cleansing attachment 200 may be substantially similar to the brush head 104, but may include an integrally formed outlet nozzle defined in the face portion of the attachment. In particular the cleansing attachment 200 may include a head portion 202 forming a top end of the attachment 200 and including a front face 236. The front face 236 may be substantially planar and optionally include a plurality of bristle apertures 212 defined through a portion of the face 236 to receive and secure the bristles 106. The arrangement of the bristles 106 across the face 236 may be varied as desired and depend on the thickness, type, and attachment methods of the bristles 106.

An outlet nozzle 226 is defined through the front face 236 and in communication with the head fluid cavity 150 and tip lumen 130. The nozzle 226 is formed as an aperture through the face 236, but may include a nozzle structure. For example, the shape of the nozzle 226 may vary along its length from the interior surface 238 of the head 202 to the exterior of the face 236. In one embodiment, the nozzle 226 may include a nozzle inlet 232 having the largest diameter of the nozzle 226 and allowing a large volume into the aperture, the nozzle inlet 232 may then taper along its length to transition to a nozzle outlet 234 having a reduced diameter as compared to the nozzle inlet 232. This change in diameter increases the speed of fluid as it exits the nozzle 226, creating a fluid jet effect. In some embodiments, the reduced diameter occurs just before the exit of the fluid, such as in the last quarter or less of the nozzle pathway through the face 236.

In the cleansing attachment of FIGS. 2A-2G, the manufacturing of cleansing assembly 200 may be easier than the brush head 104 due to fewer components forming the nozzle for the irrigating function. Further, because the nozzle 226 may be flush with the outer surface of the face 236, the nozzle 226 may not impact a user's teeth and cause discomfort or the like as a user brushes and may allow the nozzle 226 to more easily be positioned at various locations along the head portion 202.

FIGS. 2H and 2I illustrate another example of the cleansing implement of FIGS. 2A-2G. In this example, the nozzle 254 includes a uniform diameter shape as it transitions from the interior surface 238 to the exterior of the face 236. In other words, the port forming the nozzle 254 maintains its shape and size and has a constant diameter such that the inlet and outlet of the nozzle 254 are the same size. In this example, the diameter of the nozzle 254 may be reduced as compared to the inlet 232 of the nozzle 226 in FIG. 2E, to ensure that the fluid speed exiting the nozzle is increased to a desired level before exiting, since the diameter in the port does not change further to provide a supplemental increase in speed before exiting. The diameter of the nozzle 254 may be the same as the nozzle outlet 234 of FIG. 2E or may be slightly larger, depending on the desired output characteristics. The manufacturing may be slightly easier as compared to the cleansing attachment 200 since the shape of aperture in the head 202 does not change.

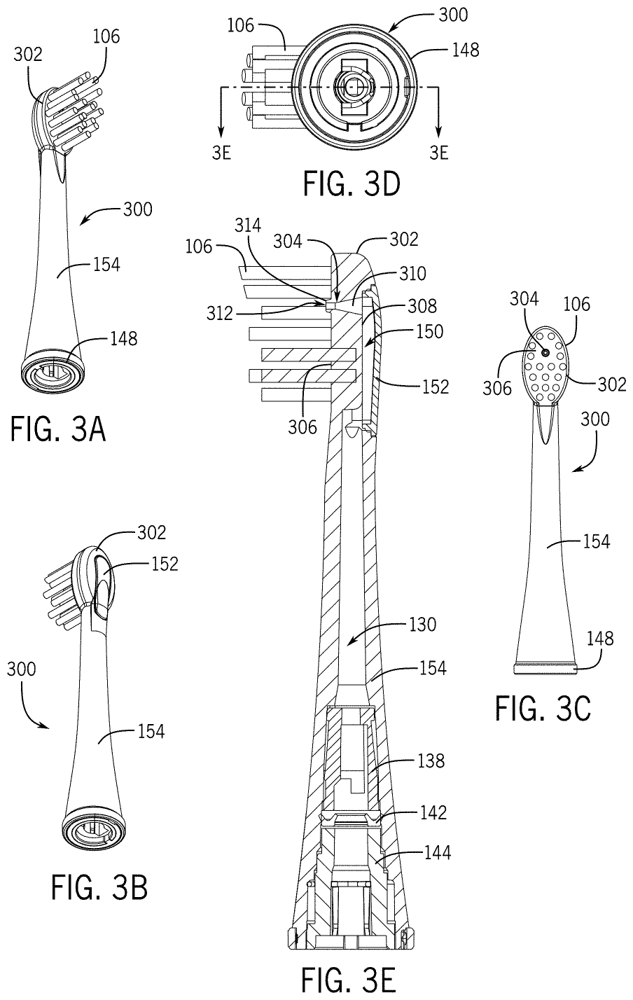

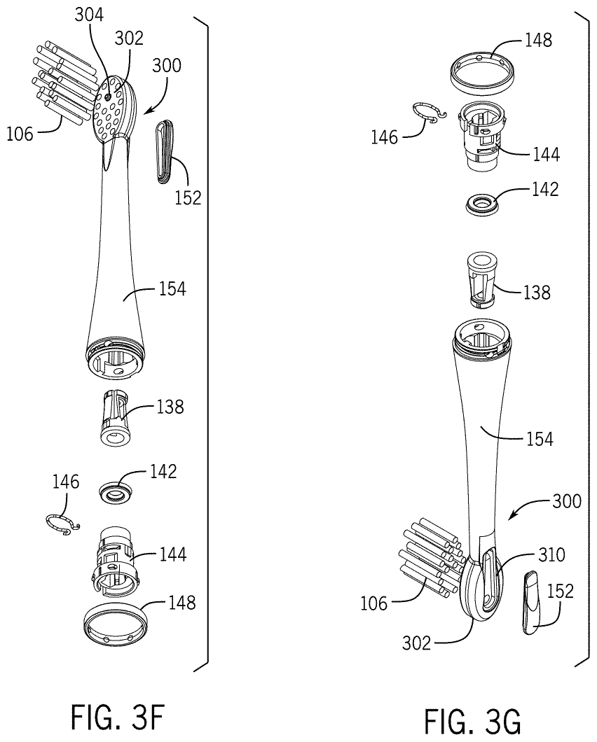

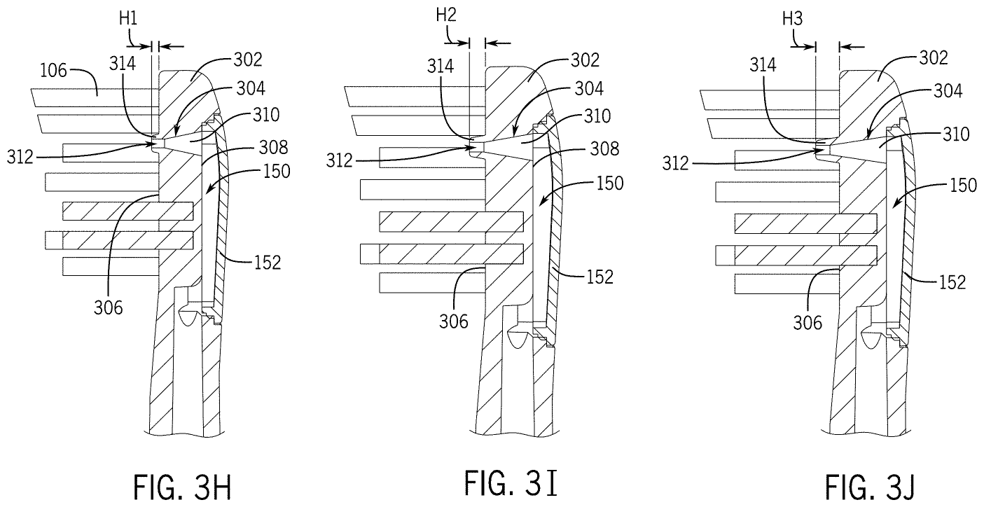

FIGS. 3A-3J illustrate another example of cleansing attachment 300. In this example, the nozzle may be formed integrally or uniformly with the brush face, similar to the cleansing attachment 200, but may extend past the outer surface of the face portion, i.e., be raised relative to the brush head face. In particular, with reference to FIGS. 3A-3E, in this example the cleansing attachment 300 includes a face portion 302 having a raised outlet nozzle 304 extending outwards from the face surface 306. The nozzle 304 may be integrally or uniformly formed with the face or head portion 302, such as through a molding process. In some examples, the nozzle 304 may have a varying diameter along its length, transitioning from a nozzle inlet 310 having the largest diameter that tapers to define a narrow nozzle outlet 312. The nozzle outlet 312 is formed in part by the face portion 302, as well as a nozzle protrusion 314 or raised nub, extending outwards from the exterior surface 306. In some examples, the nozzle outlet 312 is defined solely through the raised protrusion 314 and in other examples, the tapering forming the nozzle outlet 312 may begin with the face portion 302 and continue through the protrusion 314.

With reference to FIGS. 3H-3J, the height or extension length of the nozzle protrusion 314 may vary as desired. The higher or longer the protrusion 314, the longer the nozzle 304 may be, which may provide an increased speed of fluid as delivered to a user's oral cavity as compared to shorter protrusions 314. In these examples the nozzle 304 may be formed integrally or uniformly with the face 302 portion and as such may be formed of the same material as the tip shaft 154 and face portion 302, which may be rigid material. In these instances, the longer the nozzle protrusion 314, the more likely that it may impact a user's gums or teeth during use, which may feel uncomfortable to a user due to the harder material (as compared to the bristles 106 or elastomeric nozzle 108). As such, there may be a tradeoff between protrusion 314 height or length and fluid exit velocity. In many instances, the hard nozzle 304 may be shorter than the bristles 106 in order to provide some spacing distance to help prevent a user from inadvertently engaging the protrusion 314 against his or her gums/teeth.

In the example of FIG. 3H, the nozzle protrusion 314 may have a height H1 of approximately 0.025 inches, as defined from the exterior surface 306 of the face portion 302 to the top surface of the protrusion 314. In the example of FIG. 3I, the nozzle protrusion may have a height H2 of approximately 0.05 inches and in the example of FIG. 3J, the nozzle protrusion may have a height H3 of approximately 0.075 inches. However, substantially any other height variation may be used and the metrics shown in FIGS. 3H-3J are meant as illustrative only.

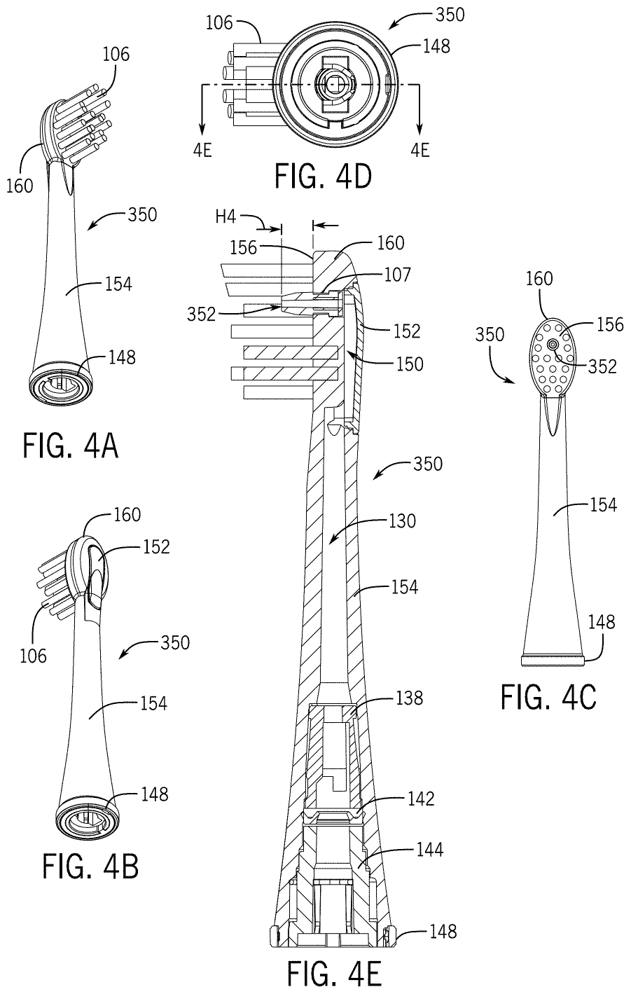

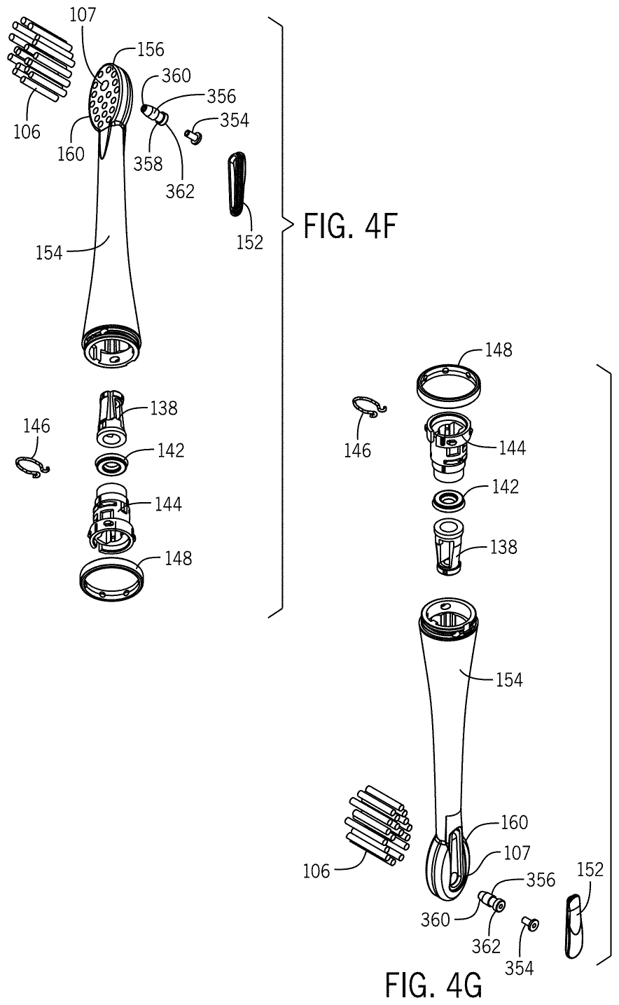

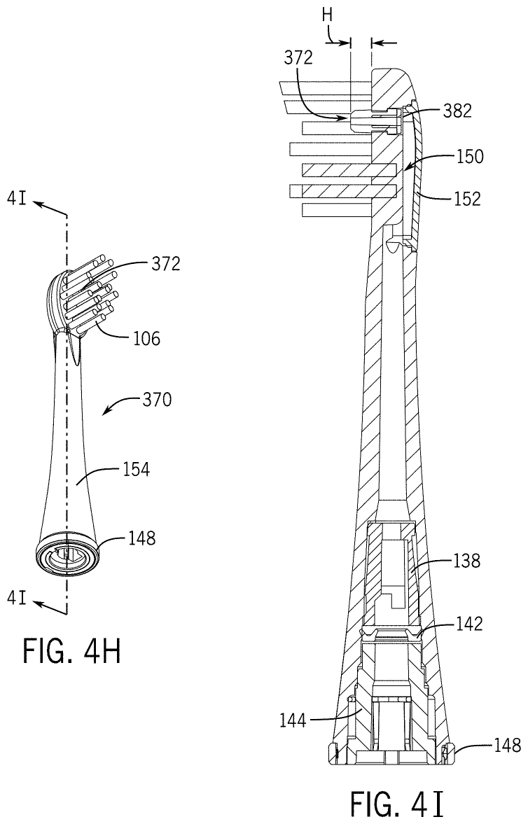

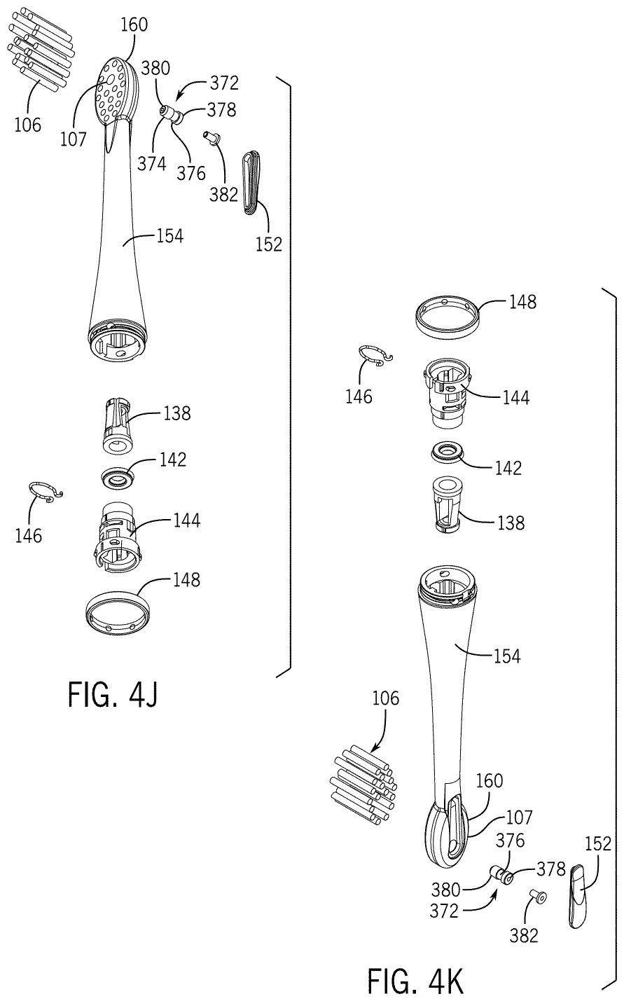

FIGS. 4A-4K illustrate a cleansing attachment with alternative nozzles. The cleansing attachments 350, 370 may be substantially similar to the brush head 104, but may include separate nozzles having shorter heights as compared to the nozzle 108. With reference to FIGS. 4A-4G, in this example, the nozzle 352 may include a spray nozzle 356 and a supporting insert 354. The spray nozzle 356 may include an outlet region 360 including an outlet port, a securing groove 358, which may be formed as an annular groove around the body, and a base portion 362. The securing groove 358 may be used to receive material of the face portion 160 to secure the nozzle 352 to the head of the cleansing attachment 350 and may be omitted or varied depending on the type of securing mechanism used to attach the nozzle to the head portion of the cleansing attachment 350. Similarly, the base portion 362 may have an expanded diameter as compared to the main body 356 to assist in anchoring the nozzle within the face portion 160 of the attachment 350.

The spray nozzle 352 may be formed of a flexible and relatively soft material as compared to the material forming the face portion 160. For example, the spray nozzle 352 may be formed of an elastomeric material that may bend when impacting a user's gums or teeth, to help prevent damage to a user's gums or teeth during use. Due to the more flexible material, the nozzle 352 may include the supporting insert 354 in order to help support the spray nozzle 352 during use. In particular, the supporting insert 354 may be a more rigid material, such as brass, other metals or alloys, in order to help ensure that the nozzle fluid pathway through the nozzle 352 remains open, e.g., that the spray nozzle body 356 does not collapse in on itself. Additionally, the insert 354 helps to provide a more rigid connection in securing the nozzle 352 to the face portion 160.

With reference to FIG. 4E, the nozzle height H, as defined from the exterior surface brush head face 156 to the outermost tip of the spray nozzle body 356, may be shorter as compared to the nozzle 108. The height H may be selected to be recessed below an outer most point of the shortest bristle 106 with the plurality of bristles, such that the nozzle 352 may be less noticeable to a user while using the device 100. In the example, the nozzle height H may range between 0.800 inches to 0.200 inches and in one example be 0.150 inches or 0.100 inches. In another example, the shortest bristle height may be 0.330 inches and the tallest bristle may be 0.440 inches and optionally may be angled. However, depending on the type of bristles used and other preferences, the height may be adjusted as desired.

FIGS. 4H-4J illustrate another example of the cleansing attachment 370 including a nozzle having a shorter length than the bristles 106. In this example, the nozzle height H may be around 0.1400 to 0.800 inches and in one example be 0.100 inches. Additionally or alternatively, the nozzle 372 may include a blunted outlet end forming a port structure. For example, the nozzle 372 may include a spray body 374 terminating in an outlet port 380 and having a cylindrical shape (as compared to the tapered conical shape of the nozzle body 356). Further, the nozzle may include a securing groove 376 defined as an annular groove around a bottom end the spray body 374 and a base expanding outwards 378 from the securing groove 376. The nozzle 372 may include an insert 382 and may be secured to the face portion 160 in a similar manner as the nozzle 352.

The reduced height H of the nozzle 372 helps to further reduce the chance that the nozzle 372 impacts the gum or teeth of user during use, as well as lead to reducing the velocity and impact of the fluid when impacting a user's gums and teeth. This shape and sizing may be preferable to users with sensitive gums since the velocity will be reduced given the extended path fluid will need to travel after exiting the nozzle as compared to other embodiments.

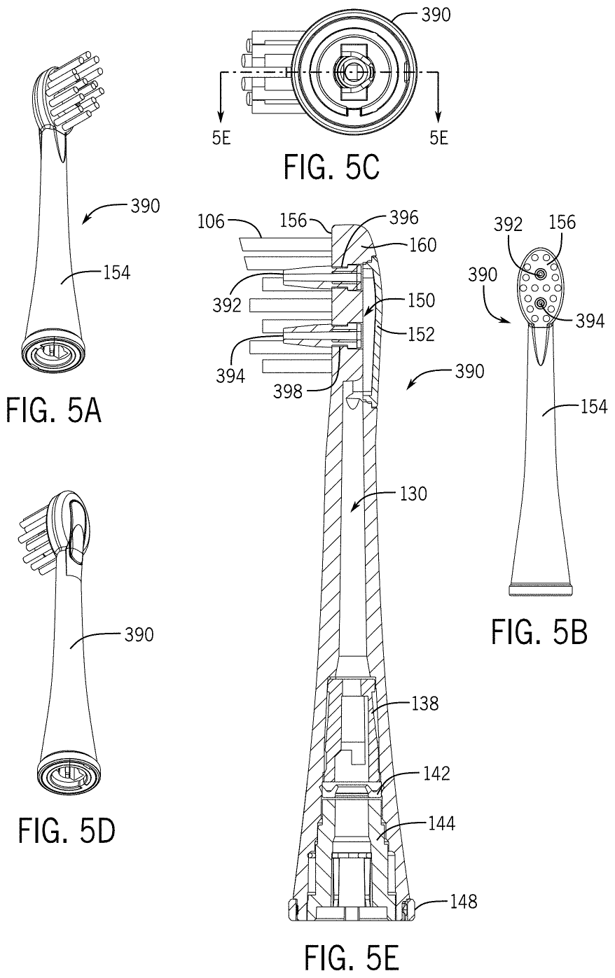

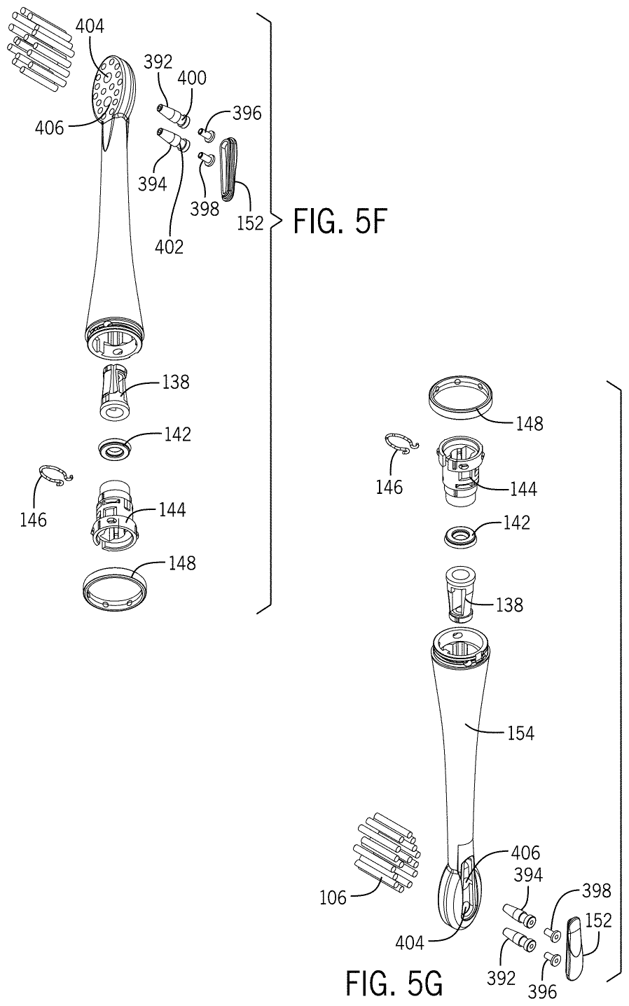

In some embodiments, the cleansing accessory may include multiple nozzles connected to the brush head. FIGS. 5A-5G illustrate various views of a cleansing accessory 390 including multiple flexible nozzles. With reference to FIGS. 5A-5G, in this embodiment, the cleansing accessory 390 may be substantially similar to the cleansing accessory 104 in FIG. 1A, but may include two or more nozzles. In particular, the brush head face 156 may define a first nozzle aperture 404 and a second nozzle aperture 406 defined through the face and in fluid communication with the tip cavity 150. In some embodiments, each of the nozzle apertures 404, 406 may be aligned with one another and in one example, may be aligned vertically along a longitudinal axis of the accessory 390. Additionally, the nozzle apertures 404, 406 may be offset or otherwise distributed on the face 156, but in the example shown in FIG. 5B may be generally aligned with a center axis of the face 156.

The cleansing accessory 390 includes two or more nozzle assemblies that are positioned within and secured to the brush head. The nozzle assemblies each include a nozzle 392, 394 and a retainer 396, 398 for securing the nozzle 392, 394 within the face 156 and ensuring that the nozzle flow path remains open when the nozzle is formed of a flexible material (e.g., soft rubber). However, in other embodiments, such as when the nozzle 392, 394 is formed of a more rigid material, the retainer 396, 398 may be omitted. The nozzles 392, 394 may also include a recessed band 400, 402 extending as an annular groove around the exterior of the nozzle body. The recessed band 400, 402 receives a portion of the face 156 material to secure the nozzles 392, 394 to the face 156.

With reference to FIGS. 5B and 5E, when assembled, the nozzles 392, 394 extend through the nozzle apertures 404, 406, respectively, and are thus oriented in the same manner as the apertures 404, 406, which may be vertically and along a center axis of the cleansing accessory 390. In this manner, as a user is using the accessory 390, a user can direct water flow to two separate locations simultaneously. The spacing between the nozzles 392, 304 may also be selected based on an average width of a user's teeth, such that when the user is directing the cleansing accessory 390 horizontally across a user's mouth (e.g., holding the handle device 100 sideways), the first nozzle 392 can direct flow into a first interstitial space and the second nozzle 394 can direct flow into a second interstitial space.

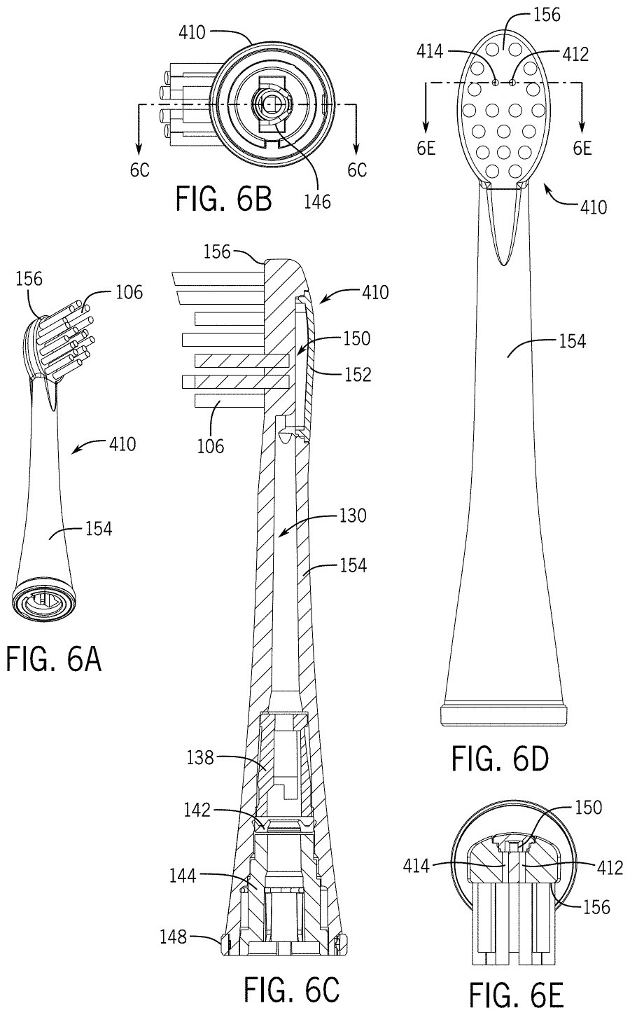

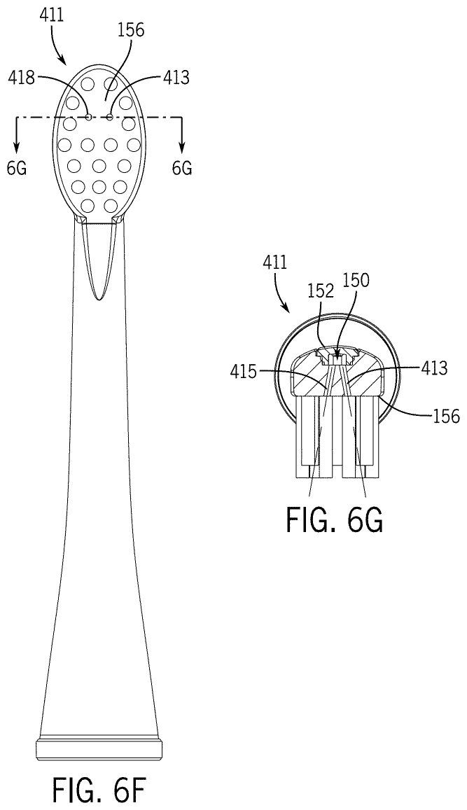

In some instances, it may be preferable to omit the flexible nozzles, instead relying on integrally defined nozzle ports. This may allow the nozzle ports to be positioned closer together and in other locations than may be possible with the separate nozzle attached to the brush face. FIGS. 6A-6E illustrate an example of the cleansing accessory 410 including multiple nozzle ports 412, 414 defined through the brush head face 156. In this example, each of the ports 412, 414 may be defined as an aperture in fluid communication with the head fluid cavity 150. The diameter of the ports 412, 414 may be constant (as shown in FIG. 6E), or may be variable to generate variations in the output flow characteristics, e.g., be tapered to increase fluid speed at the nozzle exit, or the like. The positioning of the nozzle ports 412, 414 may be varied as desired, but in one example, may be arranged to be adjacent one another and aligned in along a vertical or horizontal axis. In the example shown in FIG. 6D, the nozzle ports 412, 414 are aligned with one another along a horizontal axis extending widthwise across the brush head face 156 and the bristles 106 may be arranged around the ports 412, 414 as desired. However, in other embodiments, the nozzle ports 412, 414 may be differently arranged. For example, in the ports 412, 414 may be spaced across at opposite ends of the brush head face 156 to further space out the application of fluid.

As shown in FIG. 6D, in some embodiments, the nozzle ports 412, 414 may be positioned closer to one another as compared to the nozzle apertures 404, 406 in the cleansing accessory 390 of FIGS. 5A-5E. This is because the nozzle ports 412, 414 spacing does not need to accommodate the width of a separate nozzle component (e.g., flexible nozzle), allowing the ports 412, 414 to direct flow to substantially the same location simultaneously. This helps to ensure that the entire length of the interstitial space may receiving fluid pulses.

With reference to FIGS. 6F and 6G, in some embodiments, nozzle ports may have outlet orientations to change the exit direction of the fluid as it exits the cleansing accessory. For example, in the embodiment of FIGS. 6F and 6G, the nozzle ports 413, 415 may each extend at an angle from the rear surface of the brush head to the front face 156. In this manner, the ports 413, 415 may direct fluid in different directions from one another, rather than in the parallel direction shown in FIG. 6D. In one embodiment, the nozzle ports 413, 415 may be angled outward away from one another to direct fluid in a 0 to 45 degree angle away from a centerline of the face 156 and in one example may be between 20 to 45 degrees. However, in other embodiments, the angle and direction of the ports may be varied. Further, as discussed in more detail below, in some embodiments, the shape of the outlet may be varied to further change the characteristics of the fluid as it exits the nozzle.

In the FIGS. 6G and 6F example, the ports 413, 415 may be positioned apart from one another, but aligned horizontally on the face 156. The distance between the two ports and the edge of the face 156 may be selected based on the angle of the ports and the desired fluid path after exiting the face 156. For example, with a wider angle, the ports 413, 415 may be positioned closer together to achieve a similar exit flow path as compared to the example shown in FIG. 6G. Similarly, with a smaller angle, the ports may be positioned closer together.

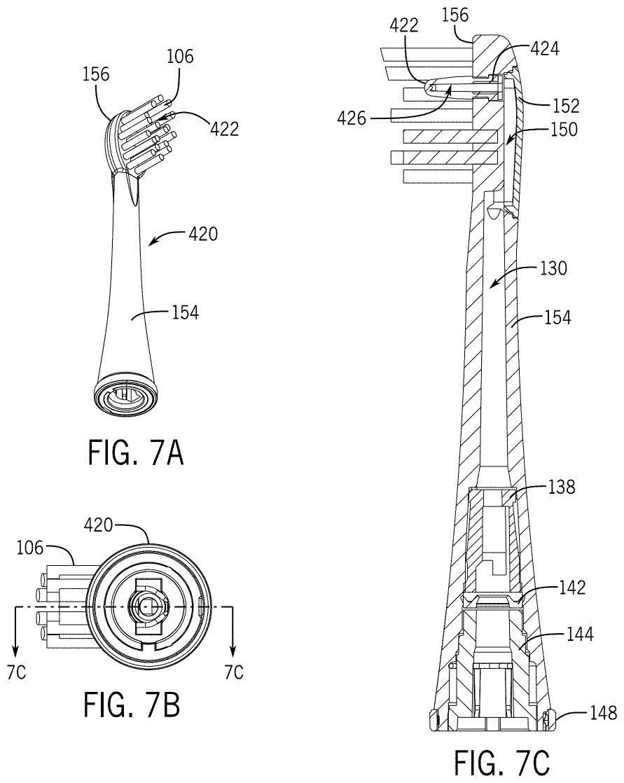

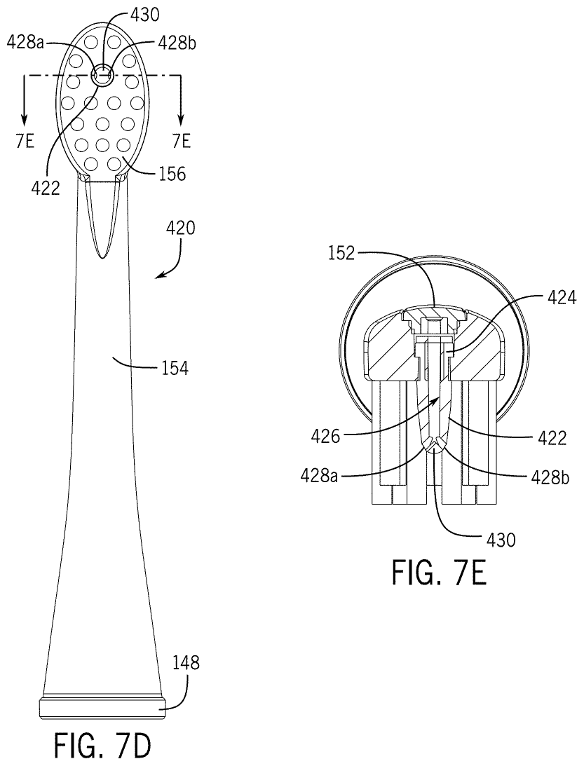

In some embodiments, the dual-outlet feature may be incorporated into a single nozzle. FIGS. 7A-7E illustrate various views of a cleansing attachment 420 including a dual-outlet nozzle 422. In this example, the nozzle 422 may be a separate component attachable to the brush head face 156 of the implement 420 and include a first outlet 428a and a second outlet 428b. In particular, the nozzle 422 may be formed as an elongated tubular member with an inlet end and a terminal end 430 and a nozzle lumen 426 defined therethrough. The terminal end 430 forms an end cap for the nozzle 422 and is sealed. However, on either side of the tip or terminal closed end 430, the two outlets 428a, 428b are defined and are in fluid communication with the nozzle lumen 426. In one example, the two outlets 428a, 428b are formed at 45 degree angles relative to the nozzle lumen 426 and defined through a sidewall of the nozzle 422. In other words, as shown in FIG. 7E, the fluid pathways through the nozzle 422 may form a Y shape with the trunk of the Y being formed by the nozzle lumen 426. In this manner, each of the outlets 428, 428b may be oriented in a different direction, such that fluid exiting from each will be directed towards a different location in a user's oral cavity. The angle and arrangement of the outlets 428a, 428b may be varied as desired. For example, the outlets 428a, 428b may be positioned in a middle section of the body of the nozzle 422, rather than towards the terminal end 430 and there may multiple outlets positioned around the perimeter of the nozzle 422. The diameter of the outlets 428a, 428b may be varied based on the length of the nozzle 422 and the desired outlet velocity and volume of the nozzle.

In some embodiments, the nozzle 422 may define two separate nozzle lumens 426 for each of the nozzle outlets 428a, 428b. In these embodiments, the outlets may be oriented to point in the same direction and provide the features of the dual nozzle attachments, without requiring two separate nozzle features.

In some embodiments, the nozzle 422 is formed of a flexible material and may include a retainer 424 for securing the nozzle 422 to the face plate 156 and providing a rigid support at the nozzle inlet to help maintain the diameter of the opening to allow water flow therethrough. However, in other embodiments, the nozzle 422 may be formed of a more rigid material or otherwise connected to the face 156 or head portion of the cleansing attachment 420 and the retainer may be omitted.

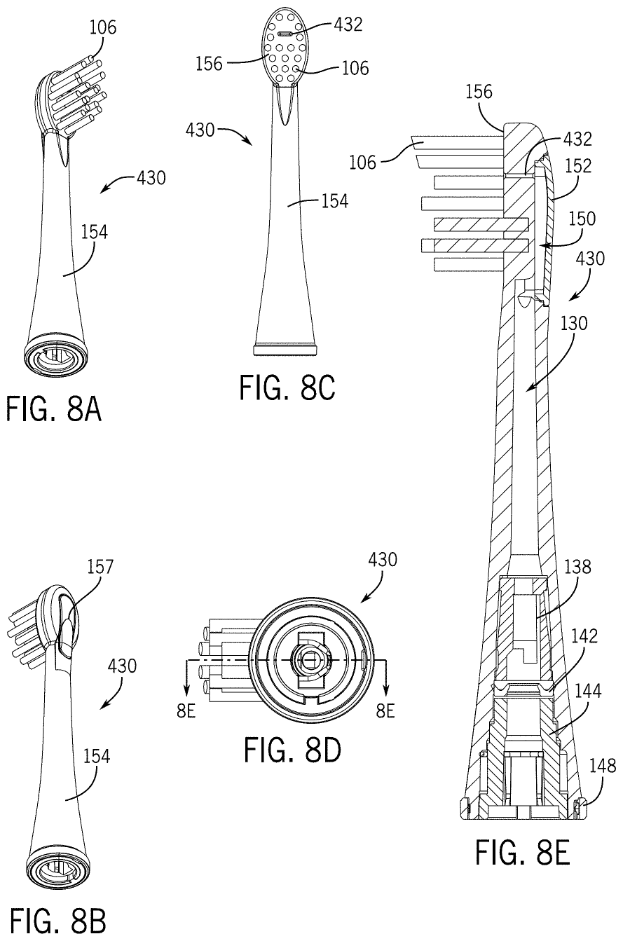

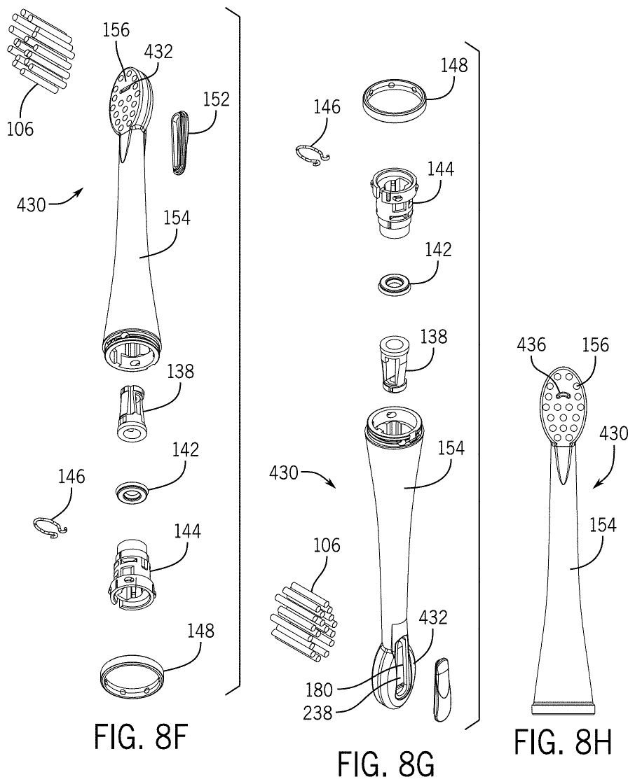

As briefly mentioned, the shape of the nozzle port may be varied to change characteristics of the fluid as it exits the cleansing accessory. FIGS. 8A-8H illustrate various views of different examples of outlet nozzle port shapes. With reference to FIGS. 8A-8G, in this example, the cleansing accessory 430 may include a nozzle port 432 defined through the face 156 and in fluid communication with the tip head cavity 150. The nozzle port 432 may be an integrally formed lumen and have an increased width or diameter access point as compared to nozzle ports in other examples. In particular, with reference to FIG. 8C, the nozzle port 432 may be defined as a slot extending laterally across a substantial width of the brush head face 156. In this example, the nozzle port 432 may have rounded side edges and straight top and bottom edges forming a rectangular shaped slot with rounded sides. In this example, the fluid may be expelled across the slot width, flattening the water stream and increasing the width forming a blade of water. In another example, the nozzle port may be shaped as a vertical slot running parallel to a longitudinal axis of the handle forming a vertically extending blade of water that may provide an extended cleaning area or length, which may require less “aiming” precision on behalf of the user during operation, especially in instances where the brush head may be oscillating.

In other embodiments, the shape of the nozzle port may be varied. With reference to FIG. 8H, in this example the nozzle port 436 may be formed as an arc with the high port of the arc being oriented generally with a central point in the face 156. In this manner, the shape of the arc of the port 436 may correspond with the curvature of the top end of the brush head. However, in other examples, the port 436 may be differently configured. For example, the port 436 may include an arc shape that mirrors the curvature of the top end.

In these examples, the width of the nozzle port 432 may be substantially constant as it extends from the interior surface of the nozzle inlet 232 of the face portion to the front face 156. However, in other embodiments, it may change in width (e.g., taper or widen) in order to further vary the fluid characteristics.

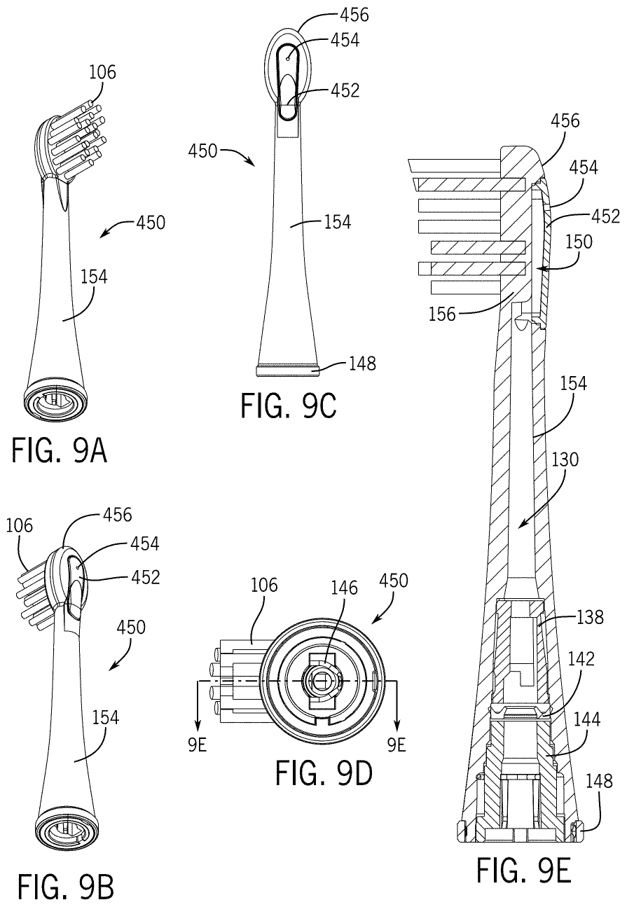

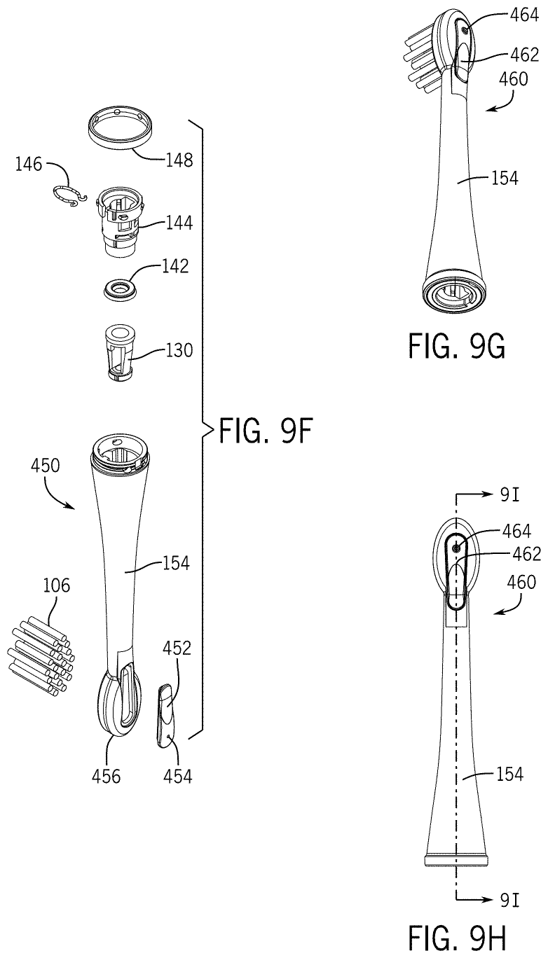

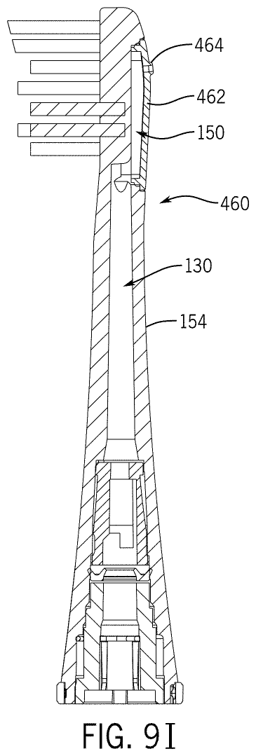

As generally described, the positioning of the nozzle may be oriented in generally the same direction as the bristles 106. However, in other instances, the nozzle may be positioned on an opposite or different side of the brushing device as the direction of extension of the bristles 106. For example, as shown in FIGS. 9A-9I, the nozzle may be oriented on the back or rear side of the cleansing attachment. This configuration allows the brushing face to have an increased surface area for bristles, allowing for an increased bristle density.

With reference to FIGS. 9A-9F, a first example of a cleansing device 450 with opposite brushing and irrigating faces is disclosed. In this example, a nozzle port 454 is defined through a rear side of the cleansing attachment 450, such as through the tip cap 452 that forms the back side of the brush head 456. In this example, the nozzle port 454 is formed as an outlet flush with the outer surface of the tip cap 452, allowing the tip cap 452 to have a relatively smooth and flat exterior surface. The diameter and configuration of the nozzle port 454 may be varied depending on the desired output characteristics therethrough and may include varying shapes, positons, and multiple apertures if desired. In operation, fluid flows into the head fluid cavity 150 from the tip lumen 130 and is expelled through the nozzle port 454 opposite of the front face 156 of the cleansing attachment 450. In this example, a user has a visible indicator as to the desired function, e.g., brushing or irrigating, and knows to rotate the device 100 into at the desired orientation for bristle or fluid contact with the user's teeth or gum line, as desired.

In this example, the flat or recessed formation of the nozzle port 454 helps to reduce uncomfortable engagement of the tip cap 452 surface with the user's teeth or gums, since in some instances the tip cap 452 may be formed of a hard plastic or the like. However, in other embodiments, brush head 456 and/or tip cap 452 may include a softer, more flexible material forming a bumper or forming the components themselves, to reduce the impact sensitivity of the brush head 456 with a user's oral features.

In some embodiments, the nozzle port may extend above the exterior surface of the tip cap to define a nozzle jet. FIGS. 9G-9I illustrate another example of a cleansing attachment 460. In this example, the nozzle 464 includes an aperture formed through the tip cap 462 and also a raised jet portion that extends past the outer surface of the tip cap 462. In some embodiments, the nozzle 464 may be formed as a nub that is relatively short to avoid interfering with a user's oral features while a user is utilizing the brushing face of the cleansing attachment 460. It should be noted that in some embodiments, the nozzle 464 may be angled relative to the center axis of the cleansing attachment 460, for example, it may be angled upwards to deliver fluid towards the top end of the brush head 462 or may be angled downwards to deliver fluid towards a bottom end of the cleansing attachment. The angle, size, diameter and positioning of the nozzle 464 depends on the desired output characteristics and may be varied as desired.

It should be noted that although in the above examples the nozzle and/or nozzle port forming a dual-faced cleansing device is formed on a separate component from the tip itself, in other embodiments it may be formed integrally within the outer wall of the tip. For example, in some embodiments, the bristles may be connected to the brush head in a variety of manners, some of which may not require the separate tip cap connected to the top end of the cleansing attachment. In these examples, the nozzle and/or nozzle port may be formed integrally with the tip body, such as being formed through a back or rear wall of the tip itself.

In some instances a single function cleansing attachment may be used with the device 100. For example, an attachment with only brushing or irrigating features may be connected and used with the device in the desired function, e.g., with either just the output motion of the output shaft activated or with just the pump and fluid output function activated. In these instances, specialized attachments may be used.

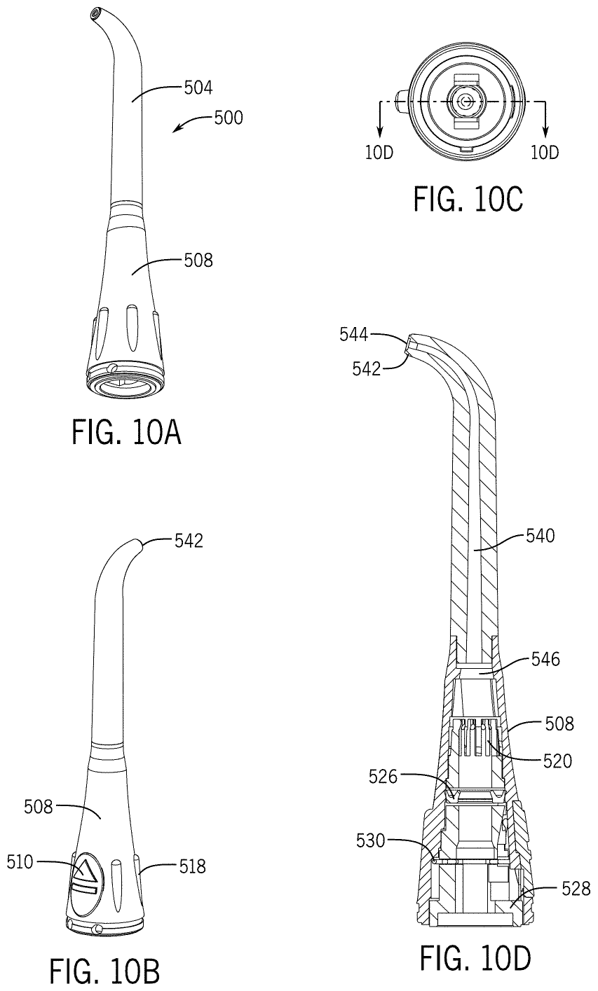

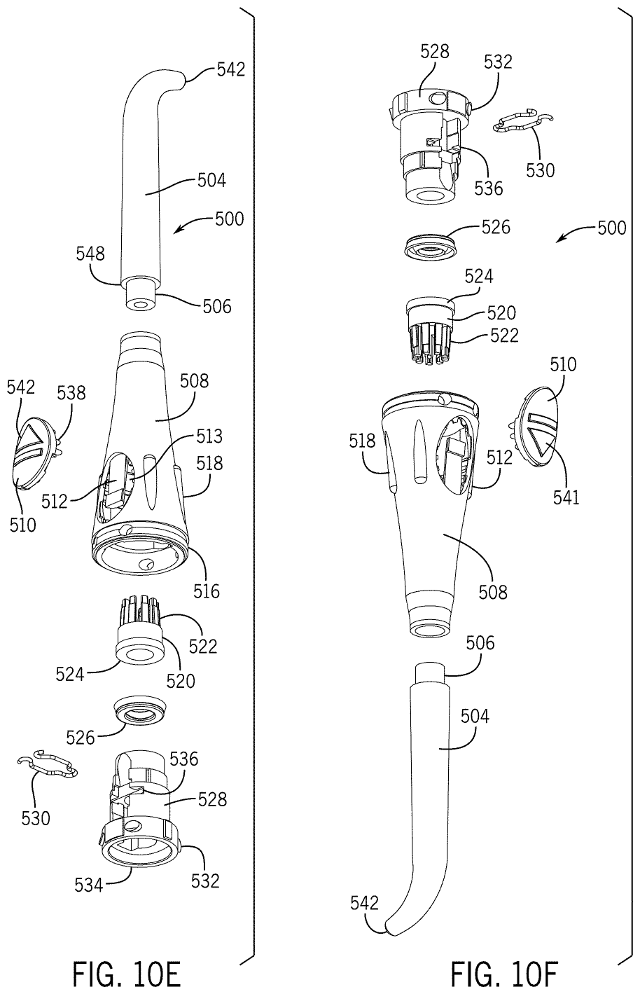

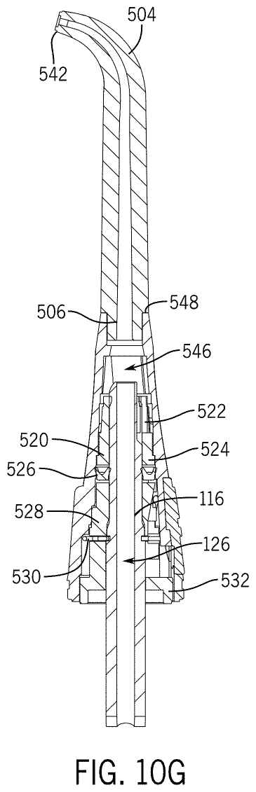

FIGS. 10A-10F illustrate an irrigating attachment 500 for use with the device 100. The irrigating attachment 500 may be connectable to the device 100 in a similar manner as the other cleansing attachments but may only include a nozzle outlet and optionally may be configured to remain stationary. In the irrigating attachment 500, the attachment 500 may include a nozzle portion 504, a connection base 508, an ejection button 510, a retainer 520, seal 526, end cap 528, and a spring 530, each of which may be coupled together. The various connection securing elements (e.g., retainer 520, end cap 528, spring 530, and seal 526) may be substantially similar to the corresponding features in the cleansing attachment 104, but modified based on the varying dimensions and features of the irrigating attachment 500.

The nozzle portion 504 may be formed as an elongated tubular member including an outlet end 542 forming a first end of the portion 504 and a connecting end 506 forming a second end. The nozzle portion 504 extends along a generally vertical or straight path and then includes a curved neck to angle the outlet end 542 at a desired angle relative to the body. The angle of the outlet end of the outlet 544 may be varied as desired, but often to more easily direct fluid at a desired location within a user's oral cavity. A tip lumen 540 is formed within the nozzle portion 504 and extends through the entire length. The tip lumen 540 terminates at a nozzle outlet 544 defined through the outlet end 542. In some embodiments, the tip lumen 540 may taper or otherwise reduce in width between the connecting end 506 and the outlet end 542, such that the diameter of the tip lumen 540 near the outlet end 542 may be smaller as compared to the diameter of the tip lumen 540 at the connecting end 506. With reference to FIG. 10E, in some embodiments, the connecting end 506 may include a reduced diameter forming a lip 548 at the transition. In these instances, the connecting end 506 forms a port extending from the bottom of the tip 504 and the lip 548 may be used to form a seamless transition with the connection base 508 as discussed below.

In some embodiments, the nozzle portion 504 may a hard plastic. Additionally, the nozzle portion 504 may be transparent or partially transparent to allow a user to see the fluid as it travels through the lumen 540. In examples where the nozzle portion 504 is transparent or clear, the connection base 508 may be an opaque material, allowing a user to view the lumen 540 to inspect for debris, but concealing the internal connection components of the attachment mechanism.

The connection base 508 is used to secure the nozzle portion 504 to the handle. In one example, the connection base 508 is a hollow frustum shaped element having a bottom end 516 that tapers inwards as it extends to the tip end. A flow lumen 546 is defined through the connection base 508. One or more raised protrusions 518, which may extend vertically along a length of the connection base 508, may be positioned at spaced apart increments along the outer surface. The raised protrusions 518 are configured to increase a frictional grip by a user to allow a user to more easily grasp the connection base 508.

In some embodiments, a button aperture 513 may be defined as an oval shaped access aperture on a front sidewall of the connection bae 508. In these embodiments, an ejection tab 512 extends into the button aperture 513 from a top interior sidewall surrounding the aperture 513. The ejection tab 512 may extend downwards from the top wall into a central region of the button aperture 513 and may include a lip or nub at its terminal end for engaging a corresponding feature on the ejection button 510.

With continued reference to FIG. 10E, the bottom end 516 of the connection base 508 may be similarly configured as the tip shaft 154 and include a recessed groove including a plurality of apertures to receive the trim ring 148.

The retainer 520 may be somewhat similar to the retainer 138 and is used to secure the irrigating attachment 500 to the handle 102. In one example, the retainer 520 includes a central support base 524 having an aperture defined through the central region and a plurality of spring engagement fingers 522 extending upwards from the top surface of the support base 524. The spring engagement fingers 522 act as detents to prevent rotation of the connection base 508 during rotation of the output shaft 116, e.g., as an anti-clocking feature.

The end cap 528 may be similar to the end cap 144 and define a housing for the latch spring 530. In one example, the end cap 528 is shaped as a series of stacked cylinders with the bottom cylinder forming a bottom end of the cap 528. A plurality of engagement tabs 532 extend outwards and are spaced apart from one another on the outer surface of the bottom cylinder. A spring slot 536 may be defined through the sidewall of the end cap 528.

The ejection button 510 is used to actuate the spring latch 530 to release the irrigating attachment 500 from the handle 102. In one example the ejection button 510 is oval shaped and includes a raised user engagement and/or instruction icon 541 on its outer surface and one more attachment prongs 538 extending laterally away from the interior surface.

To assemble the irrigation attachment 500, the retainer 520 is first inserted into the bottom end 516 of the connection base 508. The retainer 520 is pushed toward the top end of the connection base 508 and seats against an interior seat with the spring fingers 522 compressed inwards during insertion and then expanding outwards to grip the interior sidewalls of the connection base 508, to secure the retainer 520 in position. The seal 526, which may be a U-cup, O-ring, or other type of compressible member, is inserted into the connection base 508 and engages the bottom support base 524 of the retainer 520. The spring latch 530 is positioned within the latch slot 536 on the sidewall of the end cap 528 and extends across the width of the end cap 528. The end cap 528 and the spring latch 530 are then inserted into the bottom end of the connection base 508 and the top end of the end cap 528 engages the bottom surface of the seal 526 and the bottom end of the end cap 528 engages the bottom interior wall of the connection base 508.

The nozzle portion 504 is then inserted into the top end of the connection base 508 and the connecting end 506 is inserted into the aperture on the top of the connection base 508 and fluid connected to the flow lumen 546 defined therethrough. The lip 548 of the nozzle portion 504 seats on the top wall of the connection base 508 and defines a smooth or flush transition from the outer surface of the connection base 508 to the outer surface of the top end of the nozzle portion 504.

To connect the irrigating attachment 500 to the handle 102, the output shaft 116 is inserted through the end cap 528 and into the retainer 520. The latch 530 engages the securing grooves 522 of the output shaft 116, securing the irrigating attachment 500 to the handle 112. The keyed section of the output shaft 116 extends through the retainer 520, but due to the configuration of the central support base 524 does not engage or key to any internal features of the retainer 520, such that motion will not be transferred to the irrigating attachment 500 from the output shaft 116. The spring fingers 522 or detents engage the outer surface of the output shaft 116 to secure the irrigating attachment 500 in a desired direction relative to the handle. The bottom surface of the end cap 532 sits on the top end of the handle 102 and includes a diameter that substantially matches the handle top end so as to provide a flush transition between the irrigating attachment 500 and the outer surface of the handle 102.

Once the irrigating attachment 500 is positioned on the output shaft 116, the user can grip the grip features 518 on the connection base 508 to rotate the irrigating attachment 500 to a desired orientation relative to the handle 102. As the user exerts a rotational force on the irrigating attachment 500, the spring fingers 522 of the retainer 520 flex outwards relative to the output shaft 116, disconnecting therefrom, and allowing the attachment 500 to rotate to the desired location. Once in position, the user stops rotating the attachment 500, and the spring fingers 522 spring back to their initial configuration and the ends engage the output shaft 116. This engagement helps to secure the attachment 500 in position, but is sufficiently weak to allow a user to overcome the spring effect of the fingers 522 and reposition the attachment 500 as desired.

When the irrigating function is activated, fluid flows through the drive assembly and into the output shaft 116. From the outlet of the output shaft 116, the fluid is delivered into the flow lumen 546 of the connection base 508 and into the tip inlet, through the tip conduit, and out of the tip outlet 542 into a user's oral cavity. In the event the user accidentally activates the brushing function, e.g., presses the brushing control button, and the output shaft 116 begins to oscillate or rotate, the motion will not be transferred to the tip 504. In particular, the output shaft 116 will spin within the retainer 520, but the force will be sufficient to overcome the spring force of the spring fingers 522, which will flex to allow the output shaft 116 to move, without transferring motion to the connection base 508. Further, because the latch spring 530 is received within the groove 122, the output shaft 116 will simply rotate relative to the spring 530. In this manner, the tip 504 may not move within a user's mouth, even in the event that the user actuates the brushing function.

To disconnect the irrigating attachment 500 from the handle 102, the user presses the ejection button 510, such as on the instruction icon 541. The button 510 compresses inwards toward a center of the connection base 508, compressing the ejection tab 512 on the ejection base 508. This movement causes the tab 512 to move inwards and engage the spring 530, which moves laterally across the connection base 508. This movement is sufficient to disengage the spring 530 from the groove 122, allowing a user to remove the irrigating attachment 500 from the output shaft 116.

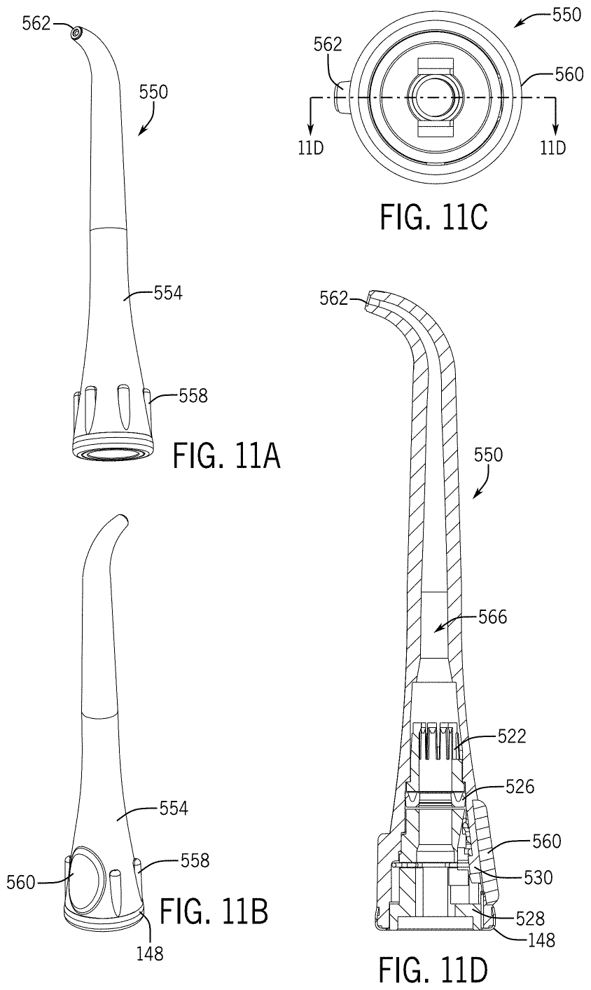

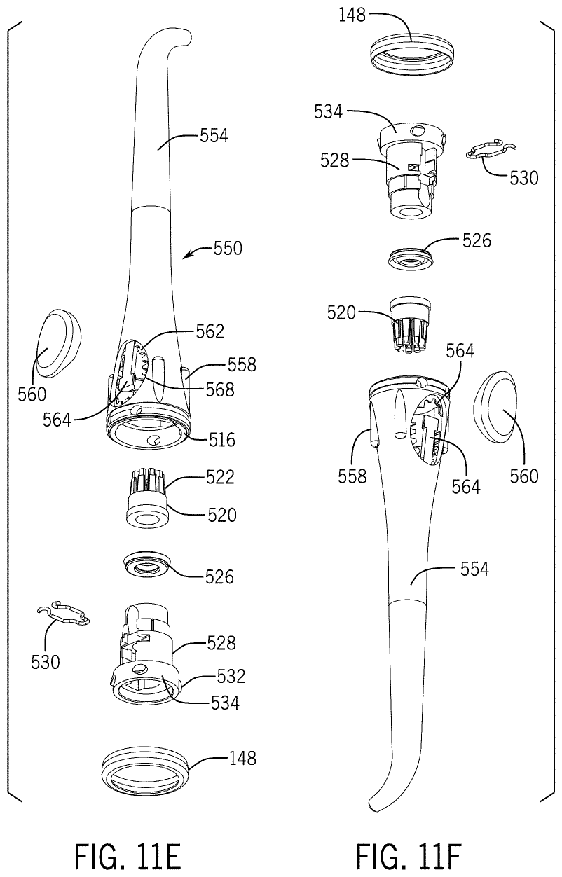

FIGS. 11A-11E illustrate another example of an irrigation attachment 550 for use with the device 100. The irrigating attachment 550 may be similar to the attachment 500 and include a connection assembly that prevents the output shaft 116 from rotating the attachment 550. In this example, the irrigating attachment 550 may include a main body 554 that is unitarily or integrally formed. For example, the main body 554 may be formed as a hollow elongated body that tapers towards the first or outlet end to define the outlet nozzle 562 and expands outwards towards the second or connection end 516 to define a frustum or skirt portion to connect to the handle and define a smooth transition therebetween. The main body 554 may be transparent and/or formed of a rubber or other softer material than the handle portion of the device. However, it should be noted that many other types of materials are envisioned.

A flow pathway 566 is defined through the length of the body 554 and is in fluid communication with the output shaft 116. One or more user grips 558 may be defined as longitudinal ribs and be spaced around the skirt or connection end 516 of the main body 554. The bottom outer surface of the connection end may include an annular recess with one or more connection apertures to secure the trim ring 148 thereto.

With reference to FIG. 11E, a button aperture 568 may be defined as an oval shaped aperture arranged on a sidewall of the skirt portion of the connection end 516. Connection features, such as an engagement tab 564 and teeth 562 may extend from the interior sidewall of the main body 554 into the opening defined by the button aperture 568. For example, the engagement tab 564 may extend downward from a top end of the button aperture 568 into a middle region of the aperture. One or more sets of teeth 562 may extend around the perimeter of the button aperture 568 and may be continuous around the edge or may be discontinuous and arranged in groups.

The irrigating attachment 550 also includes a release button 560 that actuates the latch 530 to release the attachment 550 from the handle 102. In one example, the release button 560 is an oval shaped member having a relatively smooth outer surface that may be curved to match the curvature of the connection end 516 of the main body 554. Connection features, such as corresponding teeth, prongs, recesses, or the like, may be defined on the interior surface of the button 560. These connection features engage with the connection features 562 to secure the button 560 to the main body 554, but allow the button to move relative thereto, e.g., depress inward relative to the outer surface of the main body 554.

Assembly and operation of the irrigation attachment 550 may be the same as the irrigating attachment 500. In particular, the retainer 520, seal 526, end cap 528, and latch 530 may operate as described above, to selectively secure and release the irrigating attachment 550 to and from the handle 102, fluidly connect the attachment to the output shaft 116, and prevent the attachment 550 from rotating with the output shaft 116.

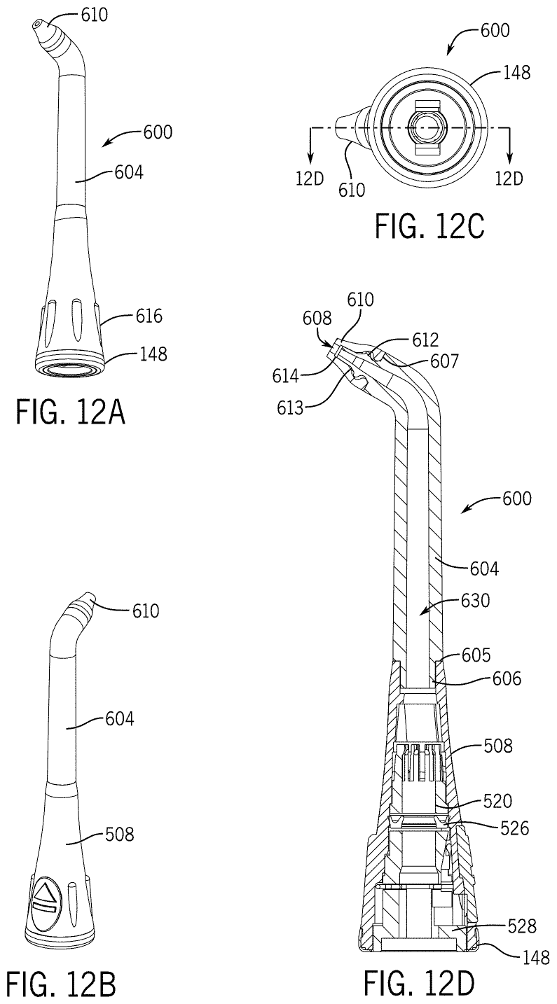

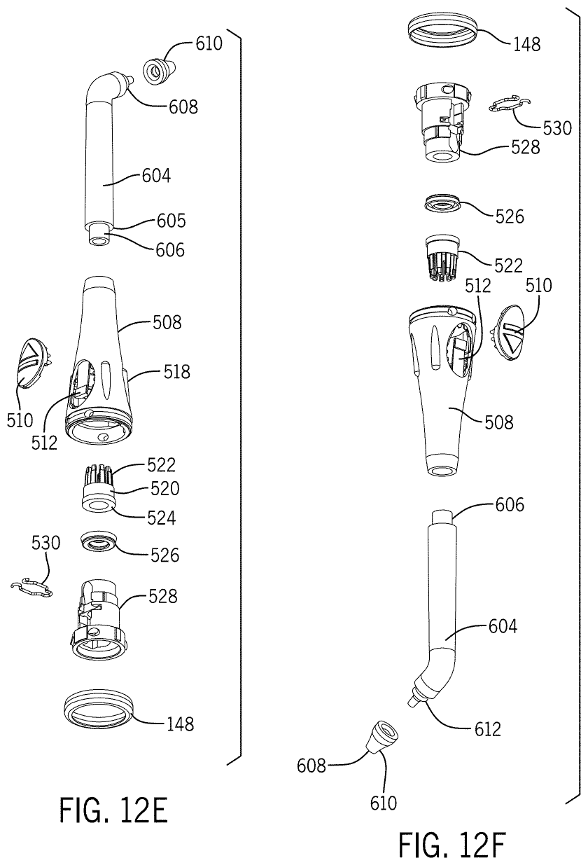

FIGS. 12A-12E illustrate another example of an irrigating attachment 600. The irrigating attachment 600 may be substantially similar to the irrigating attachment 500 and any features not specifically described may be the same as those in the irrigating attachment 500. However, in this example, a nozzle tip 610 is connected to the terminal end of a nozzle portion 604. The nozzle tip 610 may be formed of a softer material than the nozzle portion 604, such as a rubber or silicone, to be comfortable on a user's gums if the user presses the nozzle portion against his or her gums. Additionally, the nozzle tip 610 allows the outlet nozzle characteristics to be more easily varied by a user, e.g., the nozzle portion 610 can vary the outlet size and features to increase or reduce pressure, outlet speed, or the like.

In this example, the nozzle portion 604 includes a connection end 605 that steps radially inwards to define a ledge and a connection post 606. The connection post 606 may have an inlet diameter that is the same diameter as the nozzle flow pathway 630, but have a reduced wall thickness so that its outer surface is stepped inwards from the outer surface of the remaining nozzle portion 604. The connection post 606 secures to the connection base 508 in the same manner as the connection post 506 in the attachment 500.

With reference to FIGS. 12C-12E, the top end of the nozzle portion 604 includes a step in or other type of keyed element to form a connection structure of the nozzle tip 610. In one example, the connection structure includes a top seat 607 formed as an annular shelf stepped in from the outer surface of the nozzle portion 604. From the step, a connection stem 613 extends outward, the connection stem defining a bulbous ring or annular bulge 612 that extends radially around the stem 613. A stem outlet 614 is formed on the terminal end of the connection stem 613. The stem outlet 614 is in fluid communication with the nozzle lumen 630 or flow passage formed through the nozzle portion 604.

With continued reference to FIGS. 12C-12CE, the nozzle tip 610, as mentioned above, may be formed of a material having a durometer rating that is less than the nozzle portion 604, to provide a more comfortable experience to a user. The nozzle tip 610 may be generally formed as a conical attachment that tapers from a bottom end towards the top end. The top end is open and defines the nozzle outlet 608 which is in fluid communication with the stem outlet 614 when the tip 610 is attached to the nozzle portion 604. The diameter and shape of the nozzle 608 may vary as desired and in some instances may include larger or smaller variations to provide varying flow characteristics of fluid as it exits the nozzle. In some embodiments, the nozzle tip 610 includes an interior passageway that defines both a flow passageway and includes sidewalls that engage around the stem 613. In these examples, the interior passageway may vary in diameter along the length of the nozzle tip 610 or may be flexible to dynamically change in shape as it is connected to the stem 613.

In particular, to connect the tip 610 to the nozzle portion 604, the bottom end of the tip 610 is aligned with and received around the stem 613. The bottom surface of the tip 610 sits on the top seat 607 and the bulge 612 is received in a corresponding recess within the tip flow passageway. The outer surface of the tip 610 at the connection point sits flush with the outer surface of the nozzle portion 604 and the nozzle 608 is fluidly connected to the stem outlet 614. In operation, water flowing through the nozzle portion 604 lumen 630 exits the stem outlet 614 and flows into the tip 610. From the tip 610, the fluid is delivered to a user's oral cavity via the nozzle 608. Because the nozzle tip 610 may be formed of a softer material than the nozzle portion 604, the user can press the nozzle tip 610 against his or her teeth and gums to help physically remove debris and/or provide a massage force, without damage to his or her gums or teeth. Additionally, the nozzle tip 610 may be selectively removable to allow a user to interchange different tips depending on a desired output pressure or flow rate. Alternatively, the nozzle tip 610 may be overmolded or secured with adhesive or other fastener to the stem 613 to prevent inadvertent separation during use.

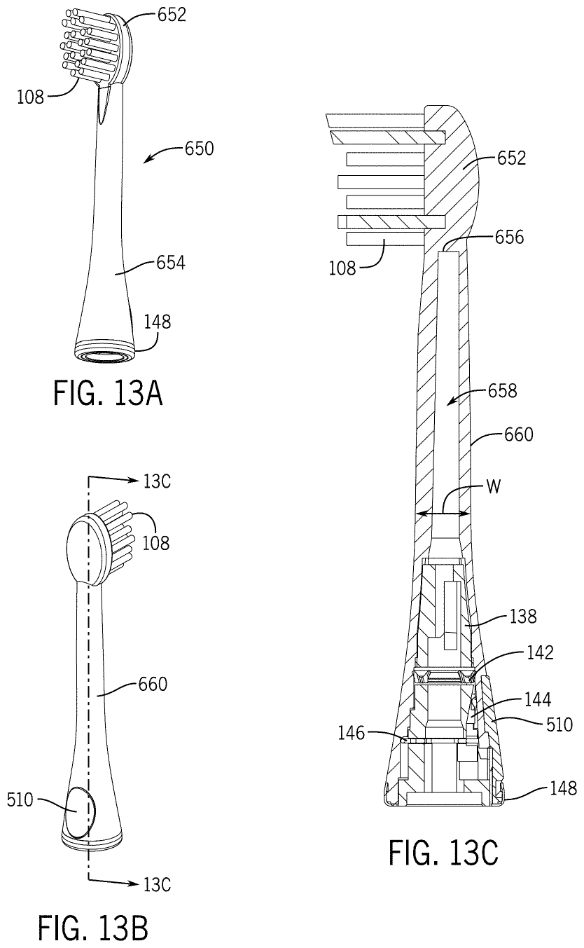

FIGS. 13A-13C illustrate another example of a cleaning implement 650 or working attachment. In this example, the cleaning implement 600 may be similar to the brush head 104, but may not include a water outlet. In other words, the cleaning implement 650 may be attachable to the handle 102, but provide a single function, brushing, rather than the irrigating function. In this example, the cleaning implement 600 may be able to be thinner than the brush head 104. With reference to FIGS. 13A-13C, in one embodiment, the cleaning implement 650 may include a main body 654 that may be formed as an elongated member that expands outwards towards a bottom end to form a skirt or enlarged connection end. The bottom diameter of the main body 654 may be selected to generally correspond to a diameter at the top end of the handle 102 such that when the implement 650 is attached to the handle 102, it forms a smooth transition. That said a width W of a middle or upper region of the main body 654 may have a dimension that is less than the handle 102 top width and less than the brush head 104. In one example, the width W is narrow, such as between half to three quarters the length of the brush head 104 of FIG. 1A. This is possible since the head is not distributing fluid to a user's oral cavity and therefor the fluid pressure and flow rate considerations in other embodiments herein may not need to be taken into account and a narrower fluid cavity can be achieved. That is, a smaller width can be used since increase in speed or pressure that typically may occur with a reduced fluid lumen, which could deliver a fluid stream at a pressure uncomfortable to a user, can be used as no fluid is actually delivered to a user.

A head portion 652 is formed on the opposite end of the main body 654 from the connection end and in one example is formed as an oval shaped protrusion and may include a convexly shaped rear exterior surface on a rear side thereof. In some embodiments, the main body 654 may be partially hollow and include a fluid cavity 658 defined through a portion thereof. However, an end wall 656 may be formed on a top end of the cavity 658 at a transition location between the body and the head 652. The end wall 656 prevents fluid from entering into the head 652. In other example, the storage or water cavity 658 may be omitted, extend into the head 652, or terminate at a lower location, e.g., in the connection region of the main body 654.

A plurality of bristles 108 are connected to the front exterior surface and may be arranged in tufts or the like. Because the implement 600 may not include a nozzle outlet, the head 652 may include more bristle tufts and/or large tufts as desired. As will be discussed below, the bristles 108 can be attached in a variety of manners, such as, but not limited to, adhesive, melting, press fit, or the like.

The cleansing implement 650 may also include a release and connection assembly or a securing assembly. The button assembly 510 may be the same as shown in the implement 500 and therefore is not described here.

In embodiments where the cleansing attachment includes bristles, the bristles may be varied in terms of flexibility, stiffness, and the like. For example, the brush head may include a first set of fibers or tufts, a set of rubber posts, or the like, where the fibers provide a first type of cleansing action against a user's teeth and the rubber posts provide a second type of cleansing action (e.g., the frictional force and surface areas are varied between the bristle types). To that end, the arrangement of the different types of bristles may be varied depending on a desired use or type of cleansing for the cleaning instrument, e.g., a tongue scraper arrangement may include rubber posts on a top end of the brush head with bristles being connected to the bottom portion of the brush head.

Similarly, different types of connection methods can be used to secure the bristles to the brush head. In one example, the bristles are connected to a brush plate and the bottom ends of the bristles are melted or otherwise fused together and the brush plate is secured to the brush head. In this example, adhesive may not be required to secure the bristles, allowing more flexibility in selecting bristle arrangements for the brush.

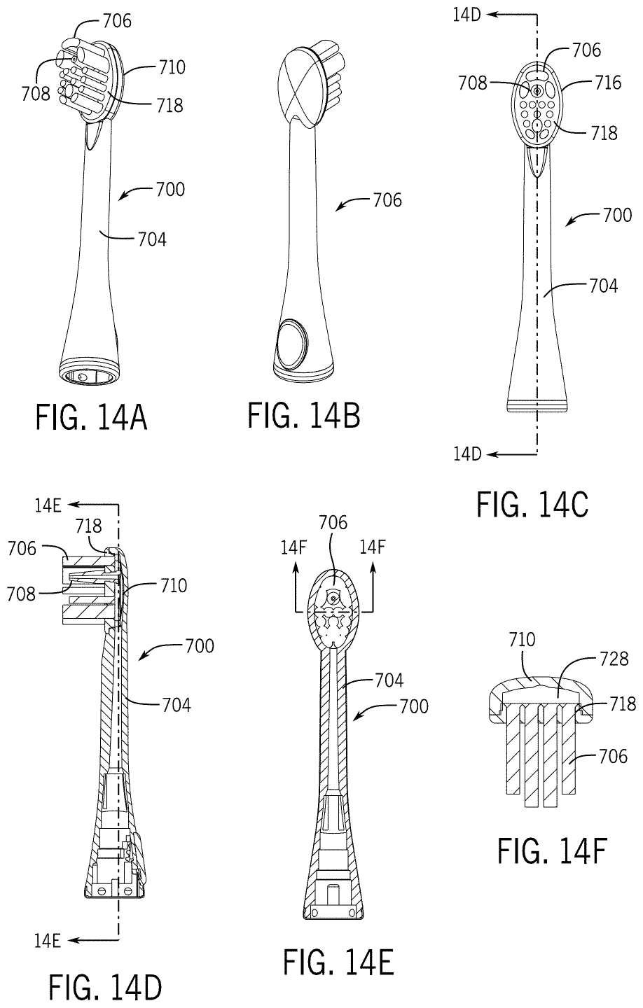

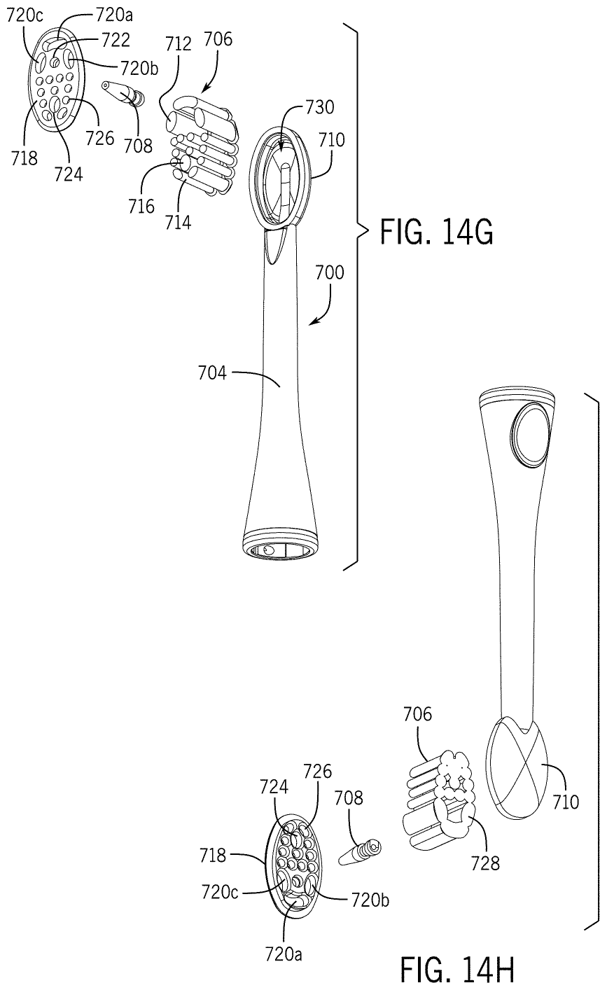

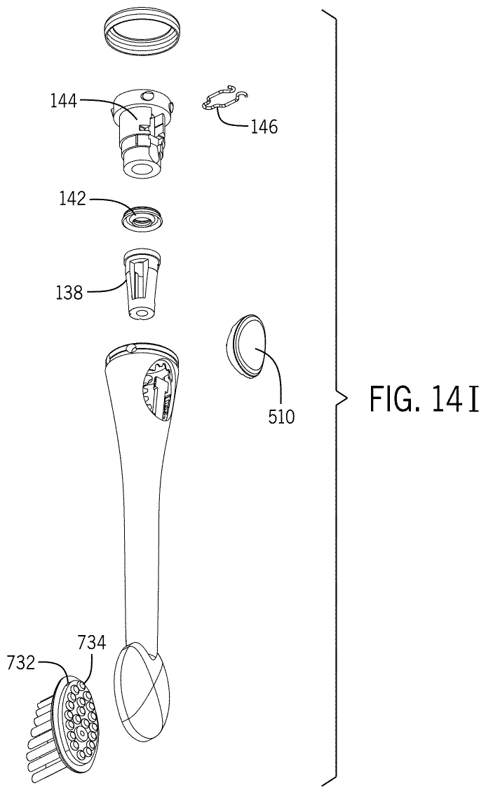

FIGS. 14A-14H illustrate an example of a brush head 700 or cleansing implement for use with the device 100. In this example, the brush head 700 includes three types of bristles, a first bristle 712 is formed of arcuate shaped tufts, a second bristle 741 group of tufts, and a third bristle 716 is a circular group of tufts. In some embodiments, each of the bristles 712, 714, 716 may be formed of bristle tufts arranged in various shapes or configurations. In other embodiments, the bristles may be formed of varying materials, e.g., rubber or the like. In these instances, the bristle types 712, 714, 716 may have varying fictional coefficients to vary the cleansing characteristics across a user's mouth as the user brushes with the brush head 700. In one example, the first bristles 712 may be arranged in a group of three around the top perimeter of the brush head 710, the third bristle 716 positioned in a lower center region of the brush head 710 and the second type of bristles 714 arranged around the third bristle 716. However, many other configurations are envisioned. The brush head 700 may also include a nozzle 708 that may be substantially the same as the nozzle 108 and be surrounded on three sides by the bristles 712.

In this example, a bristle plate 718 may be used to secure the bristles together and to the brush head 710. In one example, the bristle plate 718 may be formed as an oval shaped generally planar member and may have a diameter and shape to match a brush head cavity 730 defined by the brush head 710. The bristle plate 718 may include a plurality of bristle apertures 720a, 720b, 720b, 724, 726 and a nozzle aperture 722. The positioning of the various apertures 720a, 720b, 720c, 722, 724, 726 depends on the desired location of the bristles after assembly. As such, in one example, the apertures 720a, 720b 720c are defined as arcuate shaped slots positioned around a perimeter edge of the plate 718, the nozzle aperture 722 is positioned in an upper center of the plate 718, and the remaining apertures dispersed across the face of the plate 718.

To assemble the brush head 700, the bristles 706 are inserted into the respective apertures within the plate 718. After the bristles 706 have been inserted, the bottom ends are optionally trimmed and then the ends are heated or chemically treated to melt or alternatively, heated/chemically treated and then trimmed. As the ends melt, the material flows along the back side of the plate 718 and material from the various bristles forms together and expands radially outwards from the bristles, expanding past the perimeter edges of each of the apertures. Then, the ends are cooled or otherwise hardened. The hardening secures the bristles to the brush plate 718 due to the expanded the bottom ends that are larger than the diameter of the respective apertures, such that the bristles cannot be pulled out from the brush plate. Additionally, the material may partially melt and harden to the brush plate 718 itself, acting as an adhesive for the bristles. Once the bristles have been secured, the nozzle 708 is inserted into the nozzle aperture 722, which may be arranged sufficiently far from the bristle apertures, to be unblocked during the melting stage. The nozzle may be secured in a similar manner as described with respect to the brush head 104, e.g., with use of a retainer and flanged bottom. Alternatively, the nozzle 708 may be overmolded to the brush plate 718, either before or after the bristles are secured thereto.

As noted above, in some examples the ends of the bristles may be trimmed before or after being melted or otherwise fused together. FIG. 14I illustrates an exploded view of a brush head including trimmed bristles. As shown in FIG. 14I, in the bristle ends 734, after melting, are retained in a smaller area as compared to the larger mass of bristle ends 728 in FIG. 14H. By trimming the bristle ends, the spread of bristle material during the fusing process can be more accurately controlled or restrained. However, by omitting the trimming step, the manufacturing process can be more efficient and the bristles may be more securely attached to the brush plate 718 since there will be more material to fuse together. Additionally, the bristles may be fed or inserted into the bristle apertures through an air forced process, such as the vacuum process described in European Patent 0405204 entitled “Method and Apparatus for Forming Zones or Tufts of Bristles,” filed Jun. 8, 1990, which is hereby incorporated herein for all purposes.

With reference to FIG. 14G, the brush plate 718, with the nozzle 708 and bristles connected thereto, the brush plate 718 is secured to the brush head 710. For example, the brush plate 718 may be ultrasonically welded, molded, secured via adhesive, or via press fit connection. The removability of the front face of the brush head for the burhs head 700 allows different bristle types and arrangements to be easily attached to the same brush head 704, without requiring different tooling or the like for each of the varying types of bristle patterns desired.

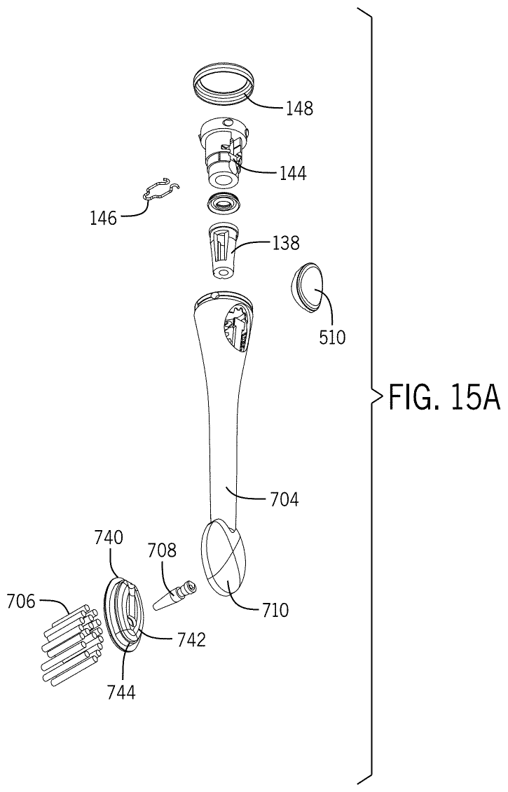

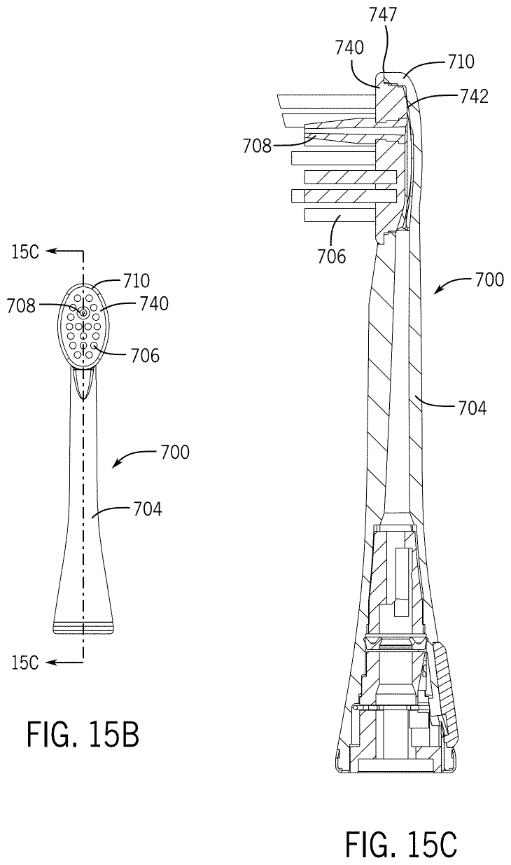

In the examples of the bristle plate 718 shown in FIGS. 14A-14I, the bristle plate is formed as a relatively planar member that secures to the brush head. However, in other examples, the bristle plate may be convexly curved or otherwise configured to seat and extend into the brush head cavity 730. As shown in FIGS. 15A and 15B, in this example, the brush head 700 includes a bristle plate 740 having a flat exterior surface and a curved or indented interior surface 742. In this example, the interior curved surface is positioned inward from an outer perimeter of the plate 740 defining a lip 744. As shown in FIG. 14B, in this example, the lip 744 seats on the outer perimeter edge of the brush head 710 surrounding the brush head cavity 730.

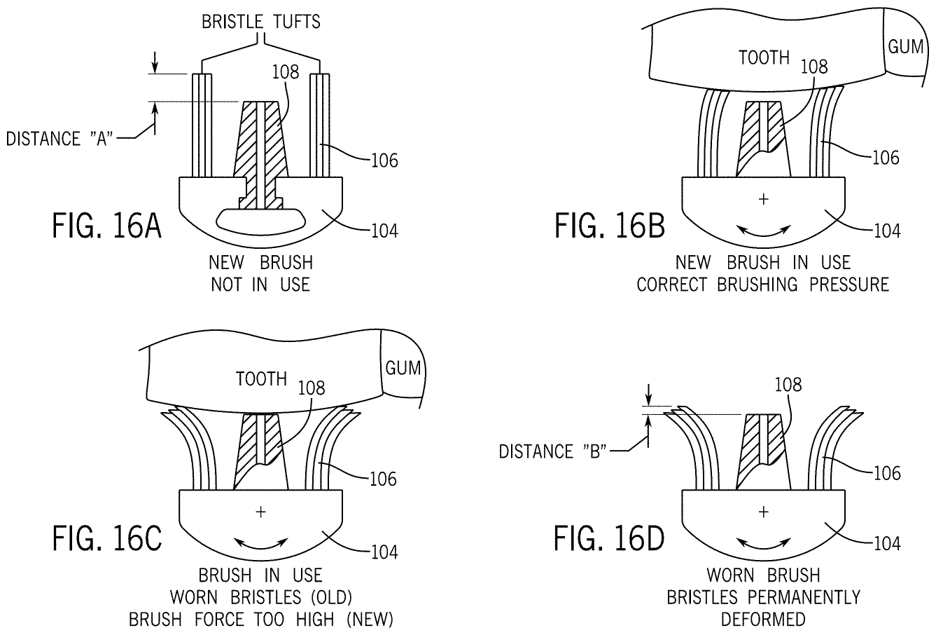

In some embodiments, the bristles 106 and nozzle 108 may be configured to provide an indication to a user of state and brushing force. FIGS. 16A-16D illustrate various views of a brush head 104 being applied against a user's tooth during use. The bristles 106 can be selected to bend or deform at predetermined forces such that if the user presses the brush head 104 too hard against his or her teeth, the bristles 106 will deflect providing tactile feedback to the user, e.g., the user will feel the nozzle 108 hitting his or her teeth. This provides instantaneous and accurate feedback to the user that the brushing force applied is too high. For example, with reference to FIG. 16A, a new brush head 104 may have bristles 106 that are aligned parallel to one another and perpendicular to the front face of the brush head 104. The bristles 106 may extend past a terminal end of the nozzle 108, such as by a distance A as shown in FIG. 16A. With reference to FIG. 16B, during proper use (e.g., proper user force), the bristles 106 on either side of the nozzle 108 bend and the nozzle 108 does not engage the tooth surface, maintaining a clearance between the teeth and the nozzle 108 (the clearance is slightly short of Distance A, adjusted for slight bristle deflection under normal use). As compared to conventional brushing force detection mechanism requiring complex sensors and springs that are prone to accuracy and malfunction, the feedback assembly provides accurate and reliable force feedback to a user.

With reference to FIG. 16C, as the bristles 106 begin to wear and/or the user applies a brushing force that exceeds a desired amount, the bristles 106 on either size of the nozzle 108 bend in opposite directions, reducing the distance A to a distance B, and the nozzle 108 tip engages the surface of the user's tooth. Then, for a worn brush head, when the user removes the brush head 104 and the user can feel the nozzle hitting or scraping on his or her teeth and understand that the brush head needs replacement and/or that the brushing force during use may be too strong.

Although the above description is discussed with respect to a dual-function device, in some embodiments, the features of the power train and other components of the handle 102 may be incorporated as a standalone brushing device. In other words, although an irrigation function is disclosed, the toothbrush may be used without the irrigating function. In these embodiments, the components including a fluid path may be omitted or modified, e.g., the output shaft may be solid rather than hollow. The nozzle may also be a solid post forming a “flossing” feature and may have varying shapes.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1-20. (canceled)

21. A cleansing attachment for use with an oral cleansing device, comprising:
a shaft defining an internal fluid passageway for receiving fluid from the device;
a brush head attached to the shaft;
a plurality of bristles attached to the brush head; and
a nozzle formed integrally with the brush head and in fluid communication with the fluid passageway for expelling the fluid from the brush head.

22. The cleansing attachment of claim 21, wherein the nozzle is formed as an aperture in a face of the brush head.

23. The cleansing attachment of claim 22, wherein the nozzle extends outward from the brush head face and is recessed relative to the plurality of bristles to provide feedback to a user regarding a brush force during use.

24. The cleansing attachment of claim 23, wherein the nozzle has a height between 0.100 to 0.150 inches.

25. The cleansing attachment of claim 21, wherein the nozzle defines a flow lumen varying in width along a length of the nozzle.

26. The cleansing attachment of claim 21, wherein the nozzle includes an inlet lumen, a first outlet port in fluid communication with the inlet lumen, and a second outlet port in fluid communication with the inlet lumen.

27. The cleansing attachment of claim 26, wherein the first outlet port and the second outlet port are arranged at different orientations relative to the inlet lumen to direct fluid in different directions relative to each other.

28. The cleansing attachment of claim 21, wherein the nozzle comprises a first nozzle and a second nozzle located at different positions on the brush head face.

29. The cleansing attachment of claim 1, wherein the nozzle is formed as a slot in a face of the brush head.

30. The cleansing attachment of claim 29, wherein the slot is arcuate shaped.

31. The cleansing attachment of claim 21, wherein the nozzle is formed as an aperture in a rear surface of the brush head.

32. The cleansing attachment of claim 31, wherein the nozzle is flush with the rear surface.

33. The cleansing attachment of claim 31, wherein the nozzle extends rearwards from the rear surface.

34. The cleansing attachment of claim 31, wherein:
the brush head includes a removable cap that at least partially defines the rear surface of the brush head; and
the nozzle is formed in the cap.

35. A cleansing attachment for use with an oral cleansing device, comprising:
a shaft defining an internal fluid passageway for receiving fluid from the device;
a brush head attached to the shaft and defining a cavity in fluid communication with the fluid passageway; and
first and second nozzles associated with the brush head and in fluid communication with the cavity for expelling fluid from the brush head.

36. The cleansing attachment of claim 35, wherein each of the first and second nozzles defines a single inlet lumen and a single outlet port.

37. The cleansing attachment of claim 35, wherein at least one of the first and second nozzles comprises an aperture formed in the brush head.

38. The cleansing attachment of claim 35, wherein at least one of the first and second nozzles comprises an elongated tubular member secured to the brush head.

39. A cleansing attachment for use with an oral cleansing device, comprising:
a shaft defining an internal fluid passageway for receiving fluid from the device;
a brush head attached to the shaft and defining a cavity in fluid communication with the fluid passageway; and
a nozzle associated with the brush head and including multiple outlet ports in fluid communication with the cavity for expelling the fluid from the brush head.

40. The cleansing attachment of claim 39, wherein:
the nozzle includes a single inlet lumen; and
the multiple outlet ports comprise a first outlet port and a second outlet port arranged at different orientations relative to the inlet lumen to direct fluid in different directions relative to each other.
